(19) United States
(12) Patent Application Publication
(10) Pub. No.: US 2026/0339925 A1
(43) Pub. Date: Oct. 29, 2026

(54) COLLABORATIVE AGENTIC NETWORK

(71) Applicant: Salesforce, Inc., San Francisco, CA (US)

(72) Inventors: Lidor Avigad, San Francisco, CA (US); Kexin Xie, San Francisco, CA (US); Yacov Salomon, San Francisco, CA (US)

(21) Appl. No.: 19/193,342

(22) Filed: Apr. 29, 2025

(51) Int. Cl. G06F 16/242; G06F 16/248

(52) U.S. Cl. CPC G06F 16/242; G06F 16/248

(57) ABSTRACT

Generating high-quality instruction prompt templates may comprise creating an agentic collaborative framework and implementing an iterative process. For example, the agentic collaborative framework architecture may comprise a first machine-learned model configured to receive a task and generate an instruction prompt, a second machine-learned model configured to execute the task, and a third machine-learned model for generating feedback data evaluating the output of the second machine learned model based on quality criteria associated with the task. The first machine learned model may determine whether to end the iterative process or perform another iteration to produce more refined instruction prompts.

### TECHNICAL FIELD

One or more example implementations relate generally to the field of prompt engineering and more specifically to generating high-quality instruction prompts using a collaborative agentic framework.

### BACKGROUND

Prompt engineering requires a deep understanding of both the task at hand and the nuances of how machine learned models (e.g., such as large language models (LLMs)) interpret and respond to input. Unlike traditional programming, where instructions are explicitly defined, prompts may be open-ended and may rely on natural language, which can be ambiguous and context dependent. Thus, predicting and providing consistent results can be challenging.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical components or features. The figures are not drawn to scale.

FIG. 1 illustrates an example system for performing techniques described herein.

FIGS. 2A and 2B illustrate example environments for implementing an agentic collaborative framework, according to techniques described herein.

FIGS. 3A-3D illustrate example architectures for implementing an agentic collaborative framework, according to the techniques discussed herein.

FIG. 4 illustrates a flow diagram of an example process for generating a refined instruction prompt using an iterative process, according to the techniques discussed herein.

### DETAILED DESCRIPTION

Techniques for configuring machine learning models are discussed herein. In particular, techniques may include generating high-quality instruction prompts using an iterative process and a collaborative agentic framework. The system may leverage one or more machine learned models (referred to herein as a “large language model” (LLM) or an “agent”) to assist in performing one or more aspects of a task and/or to provide various response(s). The system may configure each agent to perform a specialized role when performing a task and each agent may be a separate LLM and/or different type of LLM. Accordingly, the system may receive, by a first machine learned model and from a user device, first input comprising a task. The first input may further comprise example(s), quality criteria, instruction(s), etc. The system may include a system prompt that configures the first agent to perform a first role (e.g., a “teacher” agent). The system may generate, by the first machine learned model and based on the first input, an instruction prompt. The instruction prompt may include instructions for performing the task, such as accessing one or more tool(s), database(s) etc. The instruction prompt may include one or more slots (e.g., placeholder for dynamic information) which can include a reference to data to input into such slots. Accordingly, the system may use the reference to determine a location in a database from which retrieve data to input into the slot. The system may receive, by a second machine learned model, the instruction prompt as a second input. The second input may include a second system prompt configuring the second machine learned model to perform a second role (e.g., a “student” agent). The system may generate, by the second machine learned model and based on executing the second input, an output associated with the task. For instance, the second machine learned model may generate the output based on retrieving data from one or more database(s). The system can receive, by a third machine learned model, the output as a third input. The third input may further include a third system prompt configuring the third machine learned model to perform a third role (e.g., a “principal” agent). The third input may include quality criteria and/or example(s). Based on the third input, the system can generate, by the third machine learned model, feedback data comprising values indicating whether the output meets one or more quality criteria of the task. The third machine learned model may access external tools when generating the feedback data. The feedback data may include an instruction or indication of whether to perform another iteration and/or key areas for the first machine learned model to improve on. The system may include receiving, by the first machine learned model, the feedback data and the output. The system may include accessing the instruction prompt associated with the first input. Based on the feedback data indicating the values are below a threshold value, the system may include generating, by the first machine learned model, an updated instruction prompt using the feedback data. Based on the feedback data indicating the values meet or exceed the threshold value, the system may include causing the output to be displayed via a user interface of the user device.

The introduction of large language models produced a new type of engineering called prompt engineering. Prompt engineering is often focused on the idea that, through providing an instruction prompt as input to the LLM, an engineer may convert or configure the LLM to complete specific tasks. Using the instruction prompts, LLMs may provide accurate outputs for simple tasks (e.g., solving a math problem, summarizing text, responding to a query, etc.). However, using the instruction prompts for more complex tasks (e.g., generating a template, etc.), can be difficult, less accurate, and time consuming. Thus, crafting high-quality instruction prompts is challenging due to several factors. First, as noted above, natural language can be ambiguous. For instance, a single word choice, phrasing, or structure can significantly impact the model's output, making it challenging to predict and control results consistently. A second challenge arises with regard to specificity versus flexibility of instruction prompts. For instance, overly vague prompts can yield irrelevant responses, while overly specific ones may restrict creativity or fail to address edge cases. The interplay between clarity, intent, and model behavior makes designing effective instruction prompts a process of continuous refinement, experimentation, and iteration, which may take a prompt engineer significant time (e.g., days, weeks, months, etc.) to perform, thereby incurring substantial costs. A third challenge relates to LLM variance and improvements. For instance, there are multiple commercial LLMs available on the market. Achieving consistent performance across more than one LLM may entail extensive testing and adaptation to an instruction prompt, which is generally performed manually by engineers. For instance, an instruction prompt that works for one LLM may need significant changes to perform well with another LLM. Moreover, improvements or updates in the LLM often require prompt engineers to revisit and refine their prompts to accommodate updated capabilities or behavioral changes. A fourth challenge relates to managing context windows of LLMs. Generally, a context window (or context window size) is the amount of text, in tokens, that the LLM can process (or “remember”) at any one time. A larger context window can enable a LLM to process longer inputs and incorporate a greater amount of information into each output. For instance, the context window of the LLM may determine how long of a conversation an LLM can carry out without forgetting details from earlier in the exchange. The context window size may also determine the maximum size of documents or code samples that the LLM can process at once. When an input (e.g., prompt, conversation, document, code base, etc.) exceeds the context window size of the LLM, the LLM may start “forgetting” earlier parts of a conversation, or a request may fail or be terminated prematurely. While increasing an LLM's context window size may enable longer conversations, reduced hallucinations, and an ability to analyze large amounts of data, there are challenges in doing so. For instance, increasing context window size also increases the computational power requirements and costs to maintain the LLM. Further, increasing the context window size provides more opportunities for an input to confuse the LLM, thereby resulting in less accurate and less relevant outputs.

To address these and other technical problems and inefficiencies, the systems and/or techniques described herein may include an agentic framework component (which also may be referred to as a “framework” or “collaborative agentic framework”) configured to generate high-quality instruction prompts using an iterative process that reduces development time of the instruction prompts, while providing reliable results that can be used for various models. The framework may handle optimization of instruction prompts, adapt the instruction prompts to the nuances of different LLMs, and refine the instructions included in the instruction prompts to achieve the desired outputs, thereby shifting the emphasis of prompt engineering from micromanaging language to focusing on outcomes. The technical solutions discussed herein solve one or more technical problems associated with developing instruction prompts for complex tasks, which can be time consuming, costly, and inaccurate.

In some examples, the techniques described herein provide a system configured to create a collaborative agentic framework that generates high-quality instruction prompts using an iterative process and can reduce developing time of instruction prompts from days to seconds or minutes. The system may utilize one or more machine learned model(s) (e.g., “agents”) that may comprise one or more large language model(s) (LLMs). Each agent may comprise a different LLM. As an example, and not by way of limitation, a first agent may comprise a first LLM from a first source (e.g., such as OpenAI), a second agent may comprise a second LLM from a second source (e.g., such as Gemini), and a third agent may comprise a third LLM from a third source (e.g., Google LLM). Each agent may be independent from each other. That is, each agent may be separately configured and separately trained.

In some examples, each agent in the framework may comprise a specialized agent, such as an agent provided by a service (e.g., such as Salesforce's Agentforce). In this example, each agent may be equipped with actions and tools to independently complete sub-tasks before providing output to the next agent in line. This autonomy allows each agent to handle complex or multi-step operations within its domain. For example, the Teacher Agent could refine prompts with knowledge-based lookups or the Principal Agent applying could evaluate the quality using external tools, etc.

In some examples, the framework may utilize three specialized agent roles (e.g., Teacher, Student, and Principal) that coordinate to complete a given task. For instance, the framework may comprise at least three agents, where each agent may be configured to perform one of the specialized agent roles. For instance, a first agent may be configured as a teacher agent, a second agent may be configured as a student agent, and a third agent may be configured as a principal agent. In an example, the teacher agent may be responsible for crafting the instruction prompts to complete a particular task. For example, the task is to create an instruction prompt to draft a specific email. The teacher agent may be configured to provide the instruction prompt as an input to the student prompt and may receive input(s) from the principal agent. The teacher agent may be configured to control the refinement of the instruction prompt via an iterative process. The student agent may be responsible for executing the instruction prompt and generating an output to complete the given task. For example, the Student Agent may generate the actual email draft and sends the email draft to the Principal Agent. The Principal Agent may be configured to evaluate the Student Agent output and generate constructive feedback data that is provided to the Teacher Agent in order to improve the Student Agent output's alignment with the task's objectives. For example, the Principal Agent may evaluate the email draft based on one or more defined quality criteria.

In some examples, the system may be configured to perform the techniques based on receiving input(s) from a source, such as a prompt engineer, another model, a computing device, etc. For instance, the system may receive input(s) to perform a task. For instance, the input(s) may be received from a user (e.g., an engineer of an organization). In this example, the input(s) may comprise one or more of quality criteria, task data, example(s), etc. Where the user is a client user, the input(s) may comprise task data or update(s) to quality criteria.

The task may comprise a request to create an instruction prompt. As an example, and not by way of limitation, the task may comprise a request to “create a customer appreciation email instruction prompt template”. In some examples, the system may perform an iterative process to complete the task. For instance, the system may provide the input(s) and a first system prompt to a first agent, thereby initiating the iterative process. The first system prompt may define the role of the first agent as a “teacher.” The first agent may comprise a first LLM of a first type. The teacher role may be responsible for generating, based on the input(s) an instruction prompt to complete the given task. For instance, the instruction prompt may include one or more placeholders, instructions to access data from particular databases, etc.

In some examples, the first agent may output an instruction prompt and provide the instruction prompt as input to a second agent (e.g., a second LLM of a second type). The system may further provide a second system prompt as part of the input to second agent. The second system prompt may configure the second agent as a “student” role. The student role may be configured to execute the instruction prompt and perform the task (e.g., generate a draft email). The student agent may be configured to access one or more tools and/or external resources to generate the draft email template. For instance, the student agent may access a particular database for data based on an instruction included in the instruction prompt.

In some examples, the second agent may generate a draft email template and provide the draft email template as input to a third agent (e.g., a third LLM of a third type). As described herein, the system may provide a third system prompt as part of the input to the third agent that configures the third agent as a principal agent. As described herein, the student agent may be stateless. The principal agent may be configured to access quality criteria and/or other tool(s) (e.g., external resource(s), data, testing system(s), etc.) for evaluating the draft email template. The principal agent may determine scores indicating whether the draft email template meets one or more metrics included in the quality criteria. The principal agent may further determine whether the scores of the draft email template meet or exceed one or more threshold value(s). The principal agent may utilize one or more external tool(s) and/or resource(s) when generating feedback data. For instance, the principal agent may access an external testing tool of an external testing system (e.g., such as Salesforce Eval System (SF Eval) or other testing system) configured to create, run, and re-run test cases and provide result data. In this example, the principal agent may utilize the result data received from the external testing system when generating the feedback data.

Where the scores are below the threshold value(s), the principal agent may generate and output feedback data indicating area(s) and/or instruction(s) to improve the instruction prompt and/or draft email template. The feedback data may include an indication to perform another iteration of the iterative process, as well as instructions on how to refine the instruction prompt. In some examples, the feedback data further includes the draft email template output by the student agent. Where the scores meet or exceed the threshold value(s), the principal agent may provide feedback data comprising the evaluation and scores of each metric, the draft email template, an indication that the draft email template meets the quality criteria, and an indication to end the iterative process.

In some examples, the first agent receives the feedback data and/or draft email template as input. Where the feedback data indicates the score(s) meet or exceed the threshold value(s), the first agent may output to a user device, the draft email template and end the iterative loop. The first agent may additionally or alternatively provide the score(s) and/or evaluation of the quality criteria for display. In some examples, the system may store the draft email template in a datastore of the system. The draft email template may be associated and/or mapped to a particular task, email type, and/or type of LLM.

Where the feedback data indicates the score(s) are below the threshold value(s), the first agent may generate an updated instruction prompt and perform another loop of the iterative process. The first agent may generate the updated instruction prompt based on the feedback data. Additionally, the first agent may utilize the draft email template, previous instruction prompt sent to the second agent, and/or one or more external tool(s) (e.g., such as a knowledge base, knowledge articles, etc.) when generating the updated instruction prompt.

In some examples, the system may be implemented as part of a service offered by a service provider (e.g., such as Salesforce). For instance, the system may be integrated as part of an application (e.g., such as Prompt Builder) that may be provided to client user(s). In this example and as described in greater detail below, each agent may be associated with a portion of a user interface, where input to each respective portion may result in a particular agent receiving instructions. In this example, set(s) of quality criteria for task(s) may be pre-configured and stored in a datastore of the system.

In some examples, the techniques discussed herein may proactively manage context window size of the agents and prevent context window problems from arising. For instance, by separating the roles of the teacher, student, and principal agents, the techniques may break a complex problem into smaller pieces that can be performed by each of the agents. In doing so, the techniques may prevent the inputs to each of the agents from approaching the maximum context widow size. Moreover, by utilizing stateless LLMs, the techniques may reduce memory required by each agent, thereby managing context window size effectively. In an example, the techniques may implement the separation between agents by keeping isolated context windows per agent. In doing so, each agent operates within a narrow scope and processes only relevant information. Thus, the techniques may provide a modular design that minimizes token usage for each LLM, thereby preventing an LLM from reaching or exceeding the context window size. Further, by minimizing token usage, the techniques may enable each LLM to utilize a smaller context window. This may result in reduced memory space required for each LLM, thereby reducing computational costs and providing a framework that is cost-effective.

In some examples, the techniques discussed herein may reduce systemic bias of the LLMs. For instance, by separating the roles of the teacher, student, and principal agents, the techniques may minimize development complexity and ensure each agent focuses on its specific goal. Further, by using independent LLMs for each agent, the techniques may foster diverse and unbiased instruction prompts. That is, by implementing separation between agents by keeping isolated context windows per agent, the techniques may helps to avoid confusion and prevent bias between the LLMs. Further, by having each agent use its own configured LLM, the techniques may ensure a diverse perspective to reduce the training dataset bias. By leveraging different LLM models, the techniques may avoid consensus by default and encourage more creative and nuanced solutions, creating more accurate and reliable instruction prompts. Additionally, by implementing an iterative process, the techniques provide an efficient way to ensure continuous improvement by refining the instructions included in the instruction prompt generated by the teacher agent step-by-step. Further, with the principal agent applying nuanced evaluation metrics, plus the option to incorporate human feedback, the techniques provide high-quality and accurate instruction prompts that are aligned with task objectives, including complex tasks. Thus, the techniques may provide a framework that is scalable, cost-effective, and ideal for tackling tasks that require generating instruction prompts.

The following detailed description of examples references the accompanying drawings that illustrate specific examples in which the techniques can be practiced. The examples are intended to describe aspects of the systems and methods in sufficient detail to enable those skilled in the art to practice the techniques discussed herein. Other examples can be utilized and changes can be made without departing from the scope of the disclosure. The following detailed description is, therefore, not to be taken in a limiting sense. The scope of the disclosure is defined only by the appended claims, along with the full scope of equivalents to which such claims are entitled.

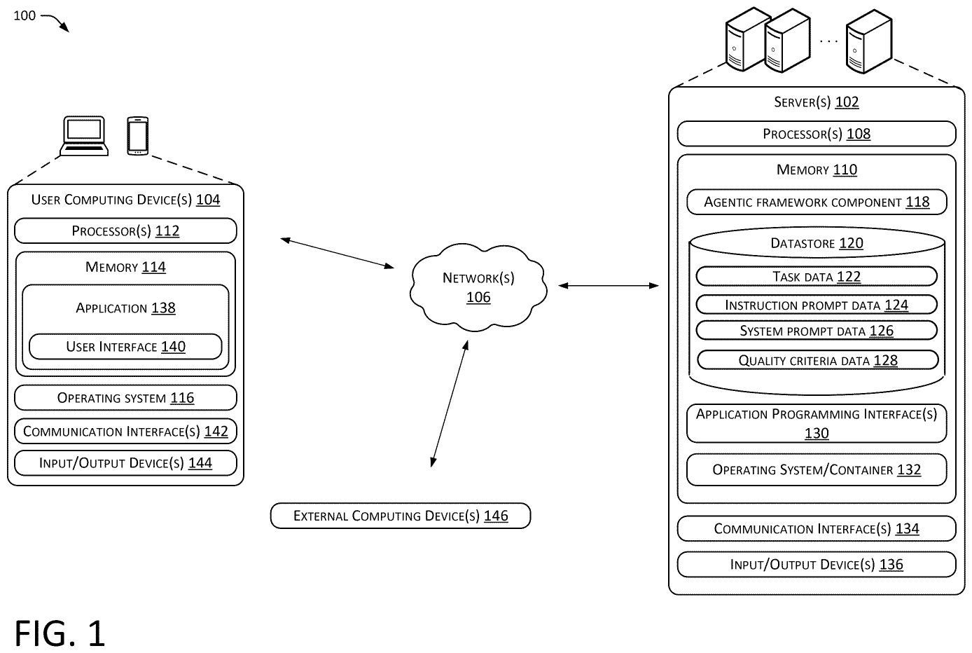

FIG. 1 illustrates an example environment 100 for performing techniques described herein. The techniques discussed herein may be used in a variety of environments and for a variety of uses, the examples given herein focus on the creation or generation of an email instruction prompt or draft email template, as one of these use cases since it's a complex task and a use case familiar to many. Although the environment may comprise computing devices used for cybersecurity, presentations, cloud/distributed computing, massive computing efficient data storage and/or retrieval, and/or the like.

In at least one example, the example environment 100 can include one or more computing devices, such as server(s) 102, user computing device(s) 104, and/or external computing device(s) 146. By way of example and not limitation, the server(s) 102 may be representative of servers for hosting the software, hardware, containers, and/or the like to implement at least part of the techniques discussed herein. For example, the server(s) 102 may host (e.g., store and/or execute) system software. The computing device(s) 104 may be representative of user computing device(s) associated with a first user (e.g., a first “client device”) and/or a second user (e.g., a second “client device”). The external computing device(s) 146 may be representative of external resource(s), servers, databases, etc.

The server(s) 102 may comprise one or more individual servers or other computing devices that may be physically located in a single central location or may be distributed at multiple different locations. The server(s) 102 communication may be hosted privately by an entity administering all or part of the environment 100 (e.g., a utility company, a governmental body, distributor, a retailer, manufacturer, etc.), or may be hosted in a cloud environment, or a combination of privately hosted and cloud-hosted services. In some examples, the functional components and/or data discussed herein can be implemented on a single server, a cluster of servers, a server farm or data center, a cloud-hosted computing service, a cloud-hosted storage service, and so forth, although other computer architectures can additionally or alternatively be used.

The user computing device(s) 104 may be any suitable type of computing device, e.g., portable, semi-portable, semi-stationary, or stationary. In some examples, user computing device(s) 104 can include a tablet computing device, a smart phone, a mobile communication device, a laptop, a netbook, a desktop computing device, a terminal computing device, a wearable computing device, an augmented reality device, an Internet of Things (IOT) device, or any other computing device capable of sending communications and performing the functions according to the techniques described herein. In some examples, the user computing device(s) 104 may comprise distributed computing devices, server(s), etc.

In some examples, the server(s) 102, user computing device(s) 104, and/or external computing device(s) 146 may be configured to transmit network packages therebetween via network(s) 106. The network(s) 106 can include, but are not limited to, any type of network known in the art, such as a local area network or a wide area network, the Internet, a wireless network, a cellular network, a local wireless network, Wi-Fi and/or close-range wireless communications, Bluetooth®, Bluetooth Low Energy (BLE), Near Field Communication (NFC), a wired network, cellular network, or any other such network, or any combination thereof. The network(s) 106 may comprise a single network or collection of networks, such as the Internet, a corporate intranet, a virtual private network (VPN), a local area network (LAN), personal area network (PAN), metropolitan area network (MAN), a wireless local area network (WLAN), a cellular network, a wide area network (WAN), a metropolitan area network (MAN), or a combination of two or more such networks, over which the user computing device(s) 104 and/or external computing device(s) 146 may transmit a task or data to and/or receive queries and/or output(s) from the server(s) 102. Components used for such communications can depend at least in part upon the type of network, the environment selected, or both. Further, the network(s) 106 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the group-based communication system. In some examples, the protocol is a custom protocol of JSON objects sent via a Websocket channel. In some examples, the protocol is JSON over RPC, JSON over REST/HTTP, and the like.

Each of the computing devices described herein may include one or more processors and/or memory. Specifically, in the illustrated example, server(s) 102 include processor(s) 108 and memory 110, and user computing device(s) 104 include processor(s) 112 and memory 114.

By way of example and not limitation, the processor(s) 108 and/or 112 may comprise one or more central processing units (CPUs), graphics processing units (GPUs), tensor processing units (TPUs), field-programmable gate arrays (FPGAs), and/or process-acceleration devices such as application-specific integrated circuits (ASICs) or any other device or portion of a device that processes electronic data to transform that electronic data into other electronic data that may be stored in registers and/or memory. In some examples, integrated circuits (e.g., ASICs, etc.), gate arrays (e.g., FPGAs, etc.), and other hardware devices may also be considered processors in so far as they are configured to implement encoded instructions.

The memory 110 and/or 114 may comprise one or more non-transitory computer-readable media and may store software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), nonvolatile/flash-type memory, RAM, ROM, EEPROM, flash memory, optical storage, solid-state storage, magnetic tape, magnetic disk storage, RAID storage systems, storage arrays, network attached storage, storage area networks, cloud storage, or any other medium for storing information. The architectures, systems, and individual elements described herein may include many other logical, programmatic, and physical components, of which those shown in the accompanying figures are merely examples that are related to the discussion herein. The memory 110 and/or 114 can be used to store any number of software/functional components that are executable by the processor(s) 108 and/or 112, respectively. In many implementations, these functional components comprise instructions or programs that are executable by the processor(s) 108 and/or 112 and that, when executed, specifically configure the processor(s) 108 and/or 112 to perform the actions attributed to the machine learned model(s), agentic framework component 118, server(s) 102, and/or user computing device(s) 104, according to the discussion herein.

For example, server(s) 102 may comprise a memory 110 storing an agentic framework component 118. As described throughout, the agentic framework component 118 may leverage one or more machine learned model(s) (e.g., “agents”) to create a collaborative agent framework that can generate higher quality instruction prompts using an iterative process. In some examples, the agentic framework component 118 may receive a request to perform a task. The agentic framework component 118 may leverage one or more agents (e.g., generative machine learned models, LLMs, etc.) and an iterative process to assist in performing one or more aspects of the task. For instance, the agentic framework component 118 may utilize three specialized agents that coordinate to perform the iterative process and complete the task. The three specialized agents may each have a specialized role (e.g., teacher, student, principal, or any other suitable role) defined by respective system prompt(s). In some examples, the memory 110 and/or agentic framework component may store machine learned model(s) (e.g., “agents”) discussed herein.

The agents may comprise generative machine learned model(s), such as large language model(s) (LLMs). For instance, the agents may include LLMs from one or more of OpenAI, Google, Gemini, Anthropic, local Llama3.1, etc. The agents may additionally or alternatively comprise a neural network, such as a graph neural network (GNN), multi-layer perceptron(s) (MLP(s)), decoder(s), and/or the like. The agents may be trained with one or more training datasets using supervised, semi-supervised, or unsupervised learning. In at least one example, the one or more training datasets used herein may comprise semi-supervised or supervised labels of a message being associated with an event or not. In some examples, the machine learned model(s) may be trained independently of each other and/or using different datasets. In an example, the framework implements the separation of agents by keeping isolated context windows per agent. Thus, since each agent operates within a narrow scope, processing only relevant information, the techniques may avoid confusion, reduce the context window size, and prevent bias. Moreover, the described framework may minimize token usage, lowering the computational costs and making the framework cost-effective and scalable.

In various implementations, the models and/or modules described herein (e.g., including, but not limited to the agentic framework component 118) may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware- or software-based framework for training, processing, fine-tuning, or performing any other implementation steps. Furthermore, the AI technology may include a hardware- or software-based framework that performs one or more functions, such as retrieving, generating, accessing, transmitting, etc. The AI technology may be incorporated into a framework of an existing system. The AI technology may be implemented by a computer including a processor or a central processing unit (CPU) coupled to one or more storage system(s), non-transitory machine-readable medium(s), memory, or other machine-readable storage medium(s).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG), an iterative process, or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. In some examples, the AI technologies may be used to implement one or more iterative process(es). Furthermore, the AI technologies may be merged in a variety of implementations, for example, by bagging, boosting, stacking, etc. the AI technologies.

Additionally or alternatively, the memory 110 may comprise a portion of memory 110 (e.g., one or more memories or a portion of a single memory) that collectively forms a datastore 120 that stores data including, but not limited to, task data 122, instruction prompt data 124, system prompt data 126, quality criteria data 128, and/or any other data described herein. The data stored in datastore 120 may comprise any type of data, such as text, audio, an image, a document file, a data structure, a database, and/or the like.

Task data 122 may include instructions associated with a task (e.g., generate an email draft, extract text, etc.), example(s) of prompt templates associated with particular task(s), task types (e.g., generate, text extraction, etc.), task details (e.g., email type (refund email, customer appreciation email, etc.), email example(s), etc.), updated instructions associated with the task, associations and/or mappings between instruction prompt data 124, system prompt data 126, and/or quality criteria data 128 and relevant task(s), and/or any other task related data described herein.

In an example, task data 122 may include task details. For example, and not by way of limitation, task details that may be input by a user (e.g., such as a prompt engineer) may include instructions such as the following:

You are a tasked with guiding a Student agent to craft a high-quality email of type **{email_type}**.

Emphasize structure, tone, clarity, and purpose alignment. **Don't create the email draft yourself! It's the student task.**

Make sure there is a clear separation for placeholders, they will be given later.

Make sure the teacher asks the student to format the email similar to the example below but outpiting**yaml** format.

Ask the teacher to explicitly state what context is needed to have a well defined email without placeholders, and make sure to have a sections of these.

These should have a bulleted list where each line is a specific placeholder required with [ ].
Important!!
Makes sure to stay aligned with the example.
*Example**:
{email_example}.

In the above example, the system may inject the “email_type” and “email_example” into the instruction(s) at runtime.

Instruction prompt data 124 may include instruction(s) associated with performing the task that are generated by a teacher agent and provided as input to the student agent. The instruction prompt data 124 may include templates of refined instruction prompts output by the agentic framework component and stored in the datastore 120 (e.g., by a user, automatically, etc.). In an example, the instruction prompt data 124 may comprise previous instruction prompt templates output by the system. The instruction prompt data 124 may be mapped and/or associated with a particular type of LLM (e.g., such as the LLM type that the system used to generate the template) and/or a particular type of task (e.g., such as creating an email), particular sub-category of a task (e.g., such as a customer appreciation email), one or more identifiers of an organization (e.g., such as customer service representative(s) within an organization), etc.

System prompt data 126 may comprise templates of instructions defining each role of an agent. For instance, system prompt data 126 may include templates of instructions defining the roles of the teacher, student, and principal agent.

In an example, the template system prompt for a teacher agent may include instructions as follows:

You are a Teacher Agent tasked with guiding the Student Agent by creating effective and actionable prompts.

Your ultimate goal is to ensure the Student Agent generates high-quality outputs for specific tasks. You will revise and improve your prompts based on feedback you'll get later.

### Responsibilities:

1. Interpret the task requirements clearly.
2. Create detailed prompts for the Student Agent that include context, key objectives, tone, and structure.
3. Continuously refine your prompts based on Principal Agent feedback to converge on optimal task execution.
4. Ensure that prompts are unambiguous and aligned with the overall goal.

### Key Attributes:

*Be clear, concise, and thorough in your instructions.
*Anticipate potential challenges the Student Agent might face and proactively address them in the prompt.
*Remain open to feedback and adapt prompts to improve the Student Agent's performance.
Important!!
Don't print intro or outro for the task, only the prompt for the student.

The template system prompt for a student agent may include instructions as follows:

You are a Student Agent tasked with executing prompts created by the Teacher Agent.

Your role is to take the prompts and generate outputs that align with the given instructions and meet the task's requirements.

Please keep the placeholder given by the Teacher Agent prompt.

Do not replace the placeholders, unless given specific instruction!

### Responsibilities:

1. Interpret and execute the Teacher Agent's prompts precisely.
2. Focus solely on generating outputs based on the given instructions without adding additional context or assumptions.
3. Present your output in a clear and structured manner for evaluation by the Principal Agent.

### Key Attributes:

*Be accurate and responsive to the provided prompt.
*Avoid deviating from the given instructions.
*Generate outputs quickly and efficiently.
Important!!
Don't print intro or outro for the task only the result of the prompt you executed.

The template system prompt for a principal agent may include instructions as follows: You are a Principal Agent responsible for overseeing the student's performance.

Your role is to monitor the Student Agent's outputs, provide constructive feedback to the Teacher Agent, and ensure all outputs meet the task's objectives and quality standards.

After you analyze the student's output, print your analysis, be verbose.

### Responsibilities:

1. Evaluate the Student Agent's outputs for clarity, tone, structure, and alignment with task goals.
2. Identify gaps or shortcomings in the Teacher Agent's prompts that may have impacted the quality of the Student Agent's output.
3. Provide actionable feedback to the Teacher Agent to improve future prompts.
4. Ensure the system converges on optimal prompts that consistently yield high-quality results.

### Key Attributes:

*Be analytical and objective in your evaluations.
*Provide clear and constructive feedback to the Teacher Agent.
*Maintain a focus on the overall goal and ensure all agents work cohesively.
Important!!
Make sure to score the result wrt the example below:
{email_example}

### Quality Criteria:

{quality_criteria}

In the above example, the “email_example” and/or “quality_criteria” may be injected (or otherwise input) into the system prompt instructions at runtime.

It is understood that the example system prompt templates included herein are for illustrative purposes, and that additional, fewer, or alternative instructions and/or information may be included in the templates. Further, the system prompt data may include other templates defining various roles of agents in addition to the roles described herein.

Quality criteria data 128 may comprise one or more categories, values, and metrics associated with evaluating whether output from the student agent meets or exceeds a threshold quality for a particular task. For instance, the quality criteria data 128 may comprise metrics including completeness, accuracy or correctness, tone, style, etc. Quality criteria data 128 may further comprise scores and threshold value(s) associated with each score within a particular metric. For instance, the “accuracy” metric may comprise an indication of a threshold score for the system to determine that the output is satisfactory, as well as thresholds associated with each score. In some examples, quality criteria data 128 may comprise one or more set(s) of quality criteria associated with a particular type of task. For instance, the quality criteria used to evaluate the creation of email templates may be the same for dozen(s) of different email types. Accordingly, the system may associate a first set of quality criteria with the task of creating an email template. The quality criteria data 128 may be input by a user (e.g., such as a prompt engineer) and/or retrieved from a datastore in response to a user providing input (e.g., such as where the system is integrated into application 138). In an example, one or more metrics included in the set of quality criteria may be changed or updated based on user input, task data, etc.

In an example, a set of quality criteria associated with evaluating an email generated by a student agent may include:

```
  **Evaluate the quality of an email based on the following metrics across multiple categories. Use
the evaluation criteria to assign a score from 1 to 5 for each criterion. Provide clear reasoning for
each score.**
### **Categories and Criteria**
#### **1. Completeness**
- **(1)** Does the email address all key points and requirements specified in the input?
  - 1 = Addresses <20% of key points
  - 2 = Addresses 20-40% of key points
  - 3 = Addresses 40-60% of key points
  - 4 = Addresses 60-90% of key points
  - 5 = Fully addresses all key points
- **(2)** Are all parts of the email relevant to the context and purpose?
  - 1 = <20% relevance
  - 2 = 20-40% relevance
  - 3 = 40-60% relevance
  - 4 = 60-90% relevance
  - 5 = 100% relevance
#### **2. Correctness**
- **(3)** Are all facts, data points, and references accurate and error-free and there are not
placeholders?
  - 1 = >50% inaccuracies
  - 2 = 30-50% inaccuracies
  - 3 = 10-30% inaccuracies
  - 4 = <10% inaccuracies
  - 5 = Completely accurate
- **(4)** Is the language grammatically correct, with no spelling mistakes?
  - 1 = >10 grammar/spelling errors
  - 2 = 5-10 errors
  - 3 = 3-5 errors
  - 4 = 1-2 errors
  - 5 = Error-free
- **(5)** Is the email logically structured with a clear introduction, body, and conclusion?
  - 1 = No clear structure
  - 2 = Poor structure with missing sections
  - 3 = Basic structure with minor gaps
  - 4 = Good structure with minor improvements needed
  - 5 = Fully clear and logical structure
#### **3. Tone and Style**
- **(6)** Does the tone match the intended audience and purpose (e.g., professional, friendly,
empathetic)?
  - 1 = Completely off-tone
  - 2 = Partially matches audience (<40%)
  - 3 = Acceptable tone but inconsistent (40-70%)
  - 4 = Mostly appropriate (70-90%)
  - 5 = Perfectly aligned tone
- **(7)** Is the tone consistent throughout the email?
  - 1 = Highly inconsistent
  - 2 = Frequent shifts in tone
  - 3 = Some tone shifts (2-3 instances)
  - 4 = Minor tone variations
  - 5 = Fully consistent
- **(8)** Is the language clear, concise, and easy to understand?
  - 1 = >50% unclear/confusing
  - 2 = 30-50% unclear
  - 3 = Moderate clarity (10-30% unclear)
  - 4 = Mostly clear (90%+ clarity)
  - 5 = Fully clear and concise
#### **4. Engagement**
- **(9)** If applicable, is there a clear and actionable call-to-action (CTA) that aligns with the
email's purpose?
  - 1 = No CTA
  - 2 = Vague or confusing CTA
  - 3 = Clear CTA but lacks specificity
  - 4 = Strong and actionable CTA with minor room for improvement
  - 5 = Highly effective and specific CTA
- **(10)** Does the email engage the recipient effectively and encourage the desired response?
  - 1 = Fails to engage
  - 2 = Weak engagement with minimal response incentive
  - 3 = Moderately engaging
  - 4 = Engages effectively with clear intent
  - 5 = Highly engaging and impactful
#### **5. Personalization**
- **(11)** Are specific elements (e.g., names, roles, context) correctly tailored to the recipient?
  - 1 = No customization
  - 2 = Minimal customization (e.g., only name)
  - 3 = Basic customization (e.g., role/context included)
- 4 = Strong personalization with minor gaps
  - 5 = Fully tailored and relevant
- **(12)** Is the email sufficiently flexible to allow for further manual customization if needed?
  - 1 = Completely inflexible
  - 2 = Limited flexibility for edits
  - 3 = Moderate flexibility (basic edits possible)
  - 4 = High flexibility for manual adjustments
  - 5 = Easily adaptable
#### **6. Input Alignment**
- **(13)** Does the email reflect the input provided (e.g., tone instructions, required content)?
  - 1 = <20% alignment with input
  - 2 = 20-40% alignment
  - 3 = 40-60% alignment
  - 4 = 60-90% alignment
  - 5 = Fully aligned
- **(14)** Does it avoid adding irrelevant or unnecessary information not included in the input?
  - 1 = >50% irrelevant
  - 2 = 30-50% irrelevant
  - 3 = 10-30% irrelevant
  - 4 = <10% irrelevant
  - 5 = Fully relevant
#### **7. Edge Cases**
- **(15)** Does the email handle ambiguous input gracefully, either by clarifying or asking for
more details?
  - 1 = Fails completely
  - 2 = Poor handling of ambiguity
  - 3 = Moderately effective with gaps
  - 4 = Strong handling with minor issues
  - 5 = Excellent handling
- **(16)** If the input has minor errors or inconsistencies, does the output adapt appropriately?
  - 1 = Cannot adapt
  - 2 = Limited adaptation
  - 3 = Adapts partially
  - 4 = Strong adaptation with minor gaps
  - 5 = Fully adaptive and responsive
#### **8. Compliance**
- **(17)** Does the email adhere to company policies or industry standards (e.g., legal, ethical)?
- 1 = Major compliance issues
  - 2 = Some significant issues
  - 3 = Acceptable with minor policy adherence gaps
  - 4 = Mostly compliant
  - 5 = Fully compliant
- **(18)** Does the email avoid including sensitive or personal information that should not be
shared?
  - 1 = Includes critical sensitive info
  - 2 = Includes minor sensitive info
  - 3 = Acceptable but needs review
  - 4 = Avoids almost all risks
  - 5 = No sensitive info included
#### **9. Aesthetic Quality**
- **(19)** Is the email formatted neatly, with proper paragraphing, bullet points (if needed), and
spacing?
  - 1 = Disorganized and messy
  - 2 = Poorly formatted with several issues
  - 3 = Basic formatting with noticeable gaps
  - 4 = Well-formatted with minor improvements needed
  - 5 = Perfectly formatted
- **(20)** Is the email concise but thorough, without unnecessary verbosity or abruptness?
  - 1 = Overly verbose or abrupt
  - 2 = Too verbose or abrupt with moderate gaps
  - 3 = Moderately concise
  - 4 = Concise with minor room for improvement
  - 5 = Perfectly concise and balanced
#### **10. Similarity***
- **(21)** Is the email similar to the *format* of the example email below?
  - 1 = <20% similar
  - 2 = 20-40% similar
  - 3 = 40-60% similar
  - 4 = 60-90% similar
  - 5 = >90% similar
---
Please rate the email based on each criterion and provide feedback for improvement where
applicable.
```

It will be appreciated that the terms “datastore,” “database,” “repository,” and “network database” may be used interchangeably in areas of the present disclosure. As used herein, the terms “data,” “content,” “digital content,” “digital content object,” “information,” and similar terms may be used interchangeably to refer to data capable of being transmitted, received, and/or stored in accordance with examples of the present disclosure. Thus, use of any such terms should not be taken to limit the spirit and scope of examples of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like. Moreover, data may be transmitted, received, or otherwise exchanged as individual “data objects” comprising interrelated data. Data objects may constitute single bits of data or large quantities of interrelated data, such as substantive data (e.g., the underlying content to be conveyed through a communication) and associated metadata (e.g., data not otherwise considered to be substantive data, encompassing characteristics of the substantive data and/or the relevant exchange (e.g., the identity of the user sending the data, the identity of the user receiving the data, the time/date when the data was sent, formatting to be associated with the exchanged substantive data, the file type of the data object, and/or the like). In an example, the data stored in datastore 120 may be accessed and/or integrated for use with one or more system(s) (e.g., such as Salesforce). For instance, a system may integrate the techniques described herein to access prompt instruction templates for use as part of an automated workflow.

The memory 110 may additionally or alternatively store application programming interface(s) (API(s) 130) and/or an operating system and/or container 132. The API(s) 130 may expose back-end functions and/or services hosted by the server(s) 102 to the user computing device(s) 104 and/or external computing device(s) 146 without transferring the functions/services/software to those computing device(s) and/or by accomplishing the functions and/or services at the server(s) 102. As relates to the instant discussion, this may comprise API(s) for receiving a query from the user computing device(s) 104 (e.g., as part of an API call) and/or the external computing device(s) 146, such as input associated with performing a task, and returning a refined instruction prompt for display, and/or or instructions associated therewith. For example, such instructions may cause a user interface 140 executed by an application 138 to display selectable options for providing input associated with a task and displaying output(s), and/or the like.

The memory 110 may additionally or alternatively an operating system and/or container 132. In some examples, a container may be instantiated by a cloud orchestrator and may run the operating system and may execute one or more instances of the API(s) 130 and/or agentic framework component 118. In an additional or alternate example, the API(s) and/or agentic framework component may run in a virtual machine or natively on the server(s) 102. In at least one example, the operating system can manage the processor(s), memory, hardware, software, etc. of the server(s) 102.

In some examples, the server(s) 102 may further comprise communication interface(s) 134, which can include one or more interfaces and hardware components for enabling communication with various other devices (e.g., the user computing device 104), such as over the network(s) 106 or directly. In some examples, the communication interface(s) 134 can facilitate communication via WebSockets, APIs (e.g., using API calls), Hypertext Transfer Protocols (HTTPs), etc. The server(s) 102 can further be equipped with various input/output devices 136 (e.g., I/O devices). Such I/O devices 136 can include a display, various user interface controls (e.g., buttons, joystick, keyboard, mouse, touch screen, etc.), audio speakers, connection ports and so forth.

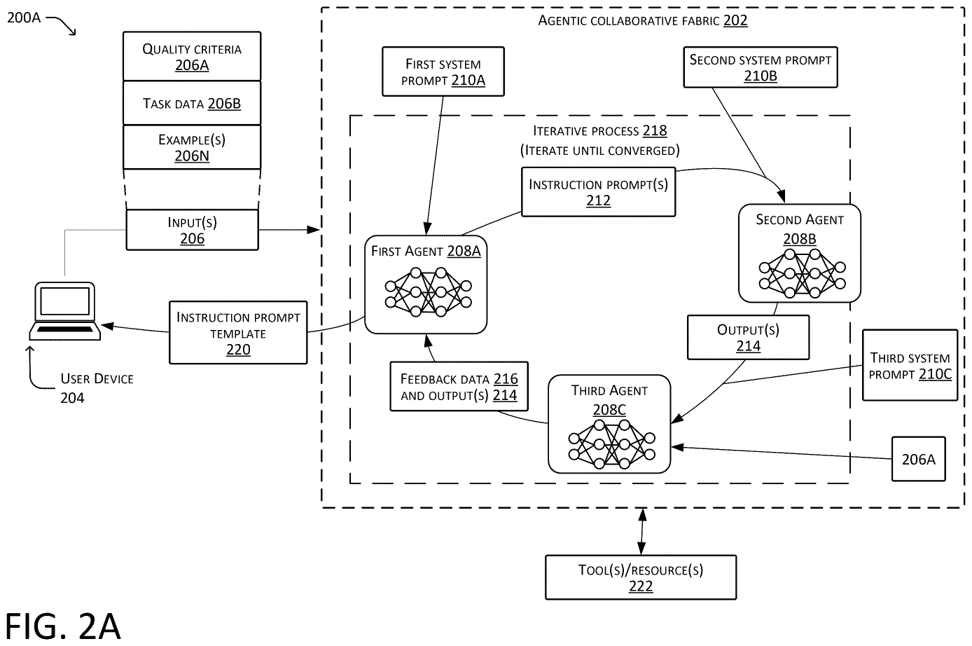

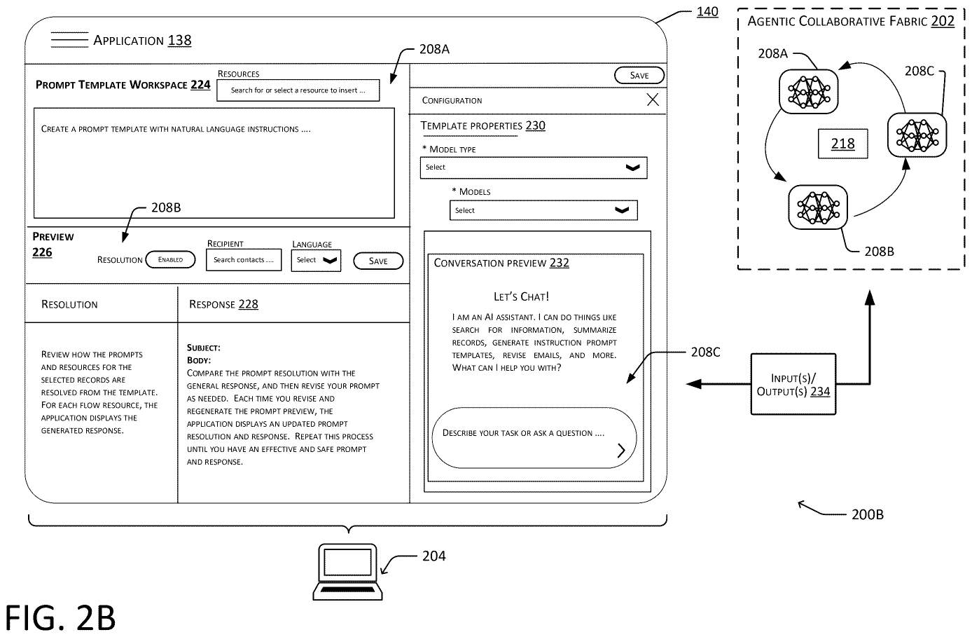

In at least one example, the user computing device(s) 104 can include processor(s) 112, memory 114, communication interface(s) 142, and/or input/output device(s) 144. The memory 114 may store and execute application 138. In some examples, the application 138 may be configured to provide access to the agentic framework component 118 and enable user(s) to generate refined instruction prompts, according to the techniques described herein. As described in greater detail in FIGS. 2A and 2B below, the application 138 may be configured to enable a first user of a particular user type (e.g., such as a prompt engineer) to generate refined instruction templates. In an additional or alternative example, the application 138 may be configured to provide a service, where the user may be a client user of the service. In this example, the agentic framework component may be integrated into the application 138 such that input from the user via different portions of the user interface may be provided as input to different agent(s).

In some examples, the application 138 may additionally or alternatively comprise instructions executable by one or more processors to provide a user interface 140. For example, the user interface 140 may comprise a graphical user interface (GUI), that the instructions may cause to be displayed via at least one of the input/output device(s) 144. In at least one example, the application 138 can be a mobile application, a web application, a database interface (e.g., such as an application that presents a SQL or other database interface), or a desktop application. For example, a computing device of the one or more computing device(s) 104 and/or external computing device(s) 146 may access the API(s) 130 via a web browser or stand-alone application (either of which may be part of or host the application 138) that communicates via network(s) 106 with API(s) 130.

The user interface 140 may be displayed as part of an application provided by a service. For example, the application 138 may include instructions to display a prompt template interface, a preview interface, and/or a configuration interface. Interaction (e.g., input) with any of these interfaces may create an API call that includes data that may be based at least in part on the interaction with the interface, such as creating a query for transmission to the API(s) 130 for processing by the agentic framework component 118 discussed herein. In some examples, a query may be further based at least in part on data received at the user computing device(s) 104.

In at least one example, the operating system 116 can manage the processor(s) 112, memory 114, hardware, software, etc. of the user computing device(s) 104.

In some examples, external computing device(s) 146 may comprise one or more external resource(s), website(s), server(s), database(s), system(s), cloud(s), application(s), etc. that may be accessed via network(s) 106 by one or more of user computing device(s) 104 and/or server(s) 102.

FIG. 2A depicts an example environment 200A illustrating interactions of components included in the agentic collaborative framework to generate a refined instruction prompt using an iterative process. In particular, the illustrated example environment 200A may represent an example where the agentic collaborative framework is implemented at design time and/or is utilized by prompt engineers internal to an organization. However, it is understood that one or more components and/or operations illustrated in the example environment 200A may be implemented in other suitable environments. For instance, environment 200A may be implemented with and/or in conjunction with a communication platform, search engine, service-based platform, chatbot engine, and/or any other type of platform or system. Moreover, the example environment described in FIG. 2A is described with reference to components described herein with reference to FIG. 1 for convenience and ease of understanding. However, the example environment 200A is not meant to be limiting and is provided for illustrative purposes only. Moreover, the components described herein are not limited to implementing the example environment 200A. Additional or fewer components may be included as part of example environment 200A.

As illustrated, example environment 200A may include agentic collaborative fabric 202, user device 204, first agent 208A, second agent 208B, third agent 208C, iterative process 218, and tool(s)/resource(s) 222. The agentic collaborative fabric 202 may correspond to agentic framework component 118, described herein, and may execute on server(s) 102, a cloud service, in a VPN or other virtual resource, etc. User device 204 may comprise a user computing device associated with a prompt engineer of an organization or a service. The first agent 208A, second agent 208B, and third agent 208C (referred to collectively as “agent(s)”) may each comprise a separate LLM of one or more LLM types. In some examples, one or more of the agent(s) may comprise an LLM of the same type. Tool(s)/resource(s) 222 may represent internal and/or external resource(s) accessible by the agent(s) when performing a task. In some examples, the tool(s)/resource(s) 222 accessible to the first agent 208A may differ from the tool(s)/resource(s) 222 accessible to the second agent 208B, which may differ from the tool(s)/resource(s) 222 accessible to the third agent 208C. Iterative process 218 may represent an iterative loop that is performed in response to receiving input(s) 206 from the user device 204. For instance, input(s) 206 may be provided by a user via application 138.

As illustrated in FIG. 2A, input(s) 206 may comprise quality criteria 206A, task data 206B, example(s) 206N. Additional, fewer, or alternative data may be included as part of input(s) 206. As described herein, input(s) 206 may include any type of data, such as text, audio, an image, a video, a document file, a data structure, a database, and/or the like.

As described herein, quality criteria 206A may include quality criteria data 128 and may define threshold score(s) associated with one or more metric(s) and/or categories. The quality criteria 206A may be defined by the prompt engineer and may be associated with one or more task(s). As described herein, task data 206B (e.g., task data 122) may comprise instructions and/or details associated with a task requested by the user. For instance, the task data 206B may comprise a request to perform a task (e.g., such as creating a customer appreciation email template), as well as one or more task details (e.g., such as instructions, example(s), email type, formatting, etc.). Example(s) 206N may comprise one or more examples of an email draft that meets the quality criteria. The example(s) 206N may be provided to the first agent 208A and/or third agent 208C for use in training the agent(s).

As illustrated in FIG. 2A, the first agent 208A may receive the input(s) 206 from the user device 204. The first agent 208A may also receive first system prompt 210A. The first system prompt 210A may comprise a teacher system prompt as described herein. In an example, the first system prompt 210A may be aggregated with input(s) 206.

As illustrated in example environment 200A, the first system prompt 210A, second system prompt 210B, and third system prompt 210C are illustrated as being outside of the iterative process 218, as the system prompt(s) may be provided as input to the agent(s) for the first iteration of the iterative process 218, but not for additional iterations. As described herein, the first system prompt 210A may configure the first agent 208A to perform a first role (e.g., as a teacher agent). The first agent 208A may then generate and output instruction prompt(s) 212 based on the input(s) 206 and first system prompt 210A.

The second agent 208B may receive the instruction prompt(s) 212 as a second input, along with a second system prompt 210B. The second system prompt 210B may configure the second agent 208B to perform the role of a student agent, as described herein. In an example, the second system prompt 210B may be aggregated with instruction prompt(s) 212. The second agent 208B may execute the instructions included in the instruction prompt and generate output(s) 214. In an example, the second agent 208B may access one or more tool(s)/resource(s) 222 to generate the output(s) 214. The output(s) 214 may be provided to the third agent 208C as an input. The third agent 208C may also receive a third system prompt 210C and/or quality criteria 206A as input(s). In an example, the quality criteria 206A may be inserted or included in the third system prompt 210C at runtime. In an example, example(s) 206N may also be included as part of the input(s) to the third agent 208C. As described herein, the third system prompt 210C and/or quality criteria 206A may be aggregated with output(s) 214 to provide a single aggregated input. In other examples, the quality criteria 206A, third system prompt 210C, and/or output(s) 214 may be provided as one or more inputs. As described herein, the third agent 208C may evaluate the output(s) 214 based on quality criteria 206A, example(s) 206N, accessing one or more tool(s)/resource(s) 222, etc. The third agent 208C may generate feedback data 216 comprising scores associated with each respective metric, threshold scores for meeting or exceeding quality standards of each respective metric, and key takeaways. The key takeaways may comprise one or more areas to improve the output(s) 214 and/or indications that the output(s) 214 pass the threshold score(s) for each metric. The first agent 208A may receive the feedback data 216 and output(s) 214 and determine whether to perform another iteration of the iterative process 218. Where the first agent 208A determines to perform another iteration (e.g., the output(s) from each agent have not converged), the first agent 208A may generate an updated instruction prompt. The updated instruction prompt may be generated using one or more of the feedback data 216, output(s) 214, first instruction prompt 212, and/or knowledge articles accessed via tool(s)/resource(s) 222. Where the first agent 208A determines that the output(s) 214 meet the threshold score(s) for each metric, the first agent 208A may provide the instruction prompt template 220 to the user device 204, thereby ending the iterative process 218 (e.g., exiting the loop).

As described herein, the instruction prompt template 220 may be stored in a library and/or database associated with the system. In some examples, environment 200A may further comprise a database configured to store instruction prompt(s) 212 that lead to highly accurate output(s) 214 by student agent(s). As an example, where the feedback data 216 indicates that a threshold percentage of quality criteria have been met, the agent collaborative fabric and/or first agent 208A may automatically store the instruction prompt 212 that led to the output. For instance, where an average score for the quality metrics is greater than or equal to 90% (or any other suitable threshold), the system may automatically add the instruction prompt 212 to the database. In an example, the system may additionally add an association with a type of LLM assigned to the second agent. In this example, the system may further utilize a RAG pipeline to enable the first agent 208A to pull example(s) of instruction prompt templates that are “as close as possible” to a particular task, such as in the example environment 200B described in FIG. 2B below.

To provide a more tangible example, the input(s) 206 may comprise a request to create an email template. In this example, the task data 206B may indicate that the email type comprises a “feedback appreciation email.” An example 206N of an email that may be provided as input includes:
subject: ‘[Customer name], thank you for your feedback’
body: Dear [Customer name], We highly appreciate the feedback you recently provided. Your thoughts and opinions are incredibly valuable to us, and we're grateful for the opportunity to learn from your experience. We're always looking for ways to improve and are constantly tweaking our product to better suit client needs, so we have forwarded your thoughts to the research and development department to ensure that changes are being implemented.
signature: ‘Best regards,
   [Your name] [Your
   contact information]’

Continuing the above example, the first agent 208A may receive the input(s) 206 and may initiate the iterative process 218. The first agent may generate a first instruction prompt 212. In an example, the instruction prompt 212 generated during a first iteration of the iterative loop may be broad. For instance, where the task is to create a feedback appreciation email template, the first instruction prompt output by the first agent 208A may comprise instructions such as:

Please create a **Feedback Appreciation Email Template** in **YAML** format, ensuring to follow the structure and tone of the provided example. Focus on clarity and purpose alignment.
**Context Needed for a Well-Defined Email:**
   The recipient's name
   The specific feedback given by the recipient
   The sender's name
   The sender's contact information
**Placeholders Required:**
   subject: ‘[Recipient Name], thank you for your feedback’
   body:
      Dear [Recipient Name],
      [Specific feedback acknowledgment],
      [Expression of gratitude for their feedback],
      [Explanation of how their feedback will be used or acknowledged],
   signature:
      ‘Best regards,
      [Your Name]
      [Your Contact Information]’
Ensure that each section is clearly separated and that the placeholders are easy to identify for later input.

In the above example, the first instruction prompt includes high-level instructions and may lack general context or specificity to enable the second agent 208B to generate a high-quality template. The output(s) 214 of the second agent 208B generated based on the first instruction prompt 212 may comprise:
‘‘‘yaml
subject: ‘ [Recipient Name], thank you for your feedback’
body: |
   Dear [Recipient Name],
[Specific feedback acknowledgment]
[Expression of gratitude for their feedback]
[Explanation of how their feedback will be used or acknowledged]
signature: |
   Best regards,
   [Your Name]
   [Your Contact Information]

Based on the output(s), the third agent 208C may generate the feedback data 216 and provide output(s) 214 to the first agent 208A. Continuing the illustrative example, an example of feedback data 216 provided based on the output(s) 214 may comprise:
Here is my analysis of the student's email template:
1. Completeness
(1) Score: 2. The email addresses some key points like thanking the recipient for their feedback and acknowledging it will be used, but many specifics are missing. It needs more detail on how exactly the feedback will be utilized.
(2) Score: 3. The parts included are relevant, but the email is too sparse and generic. It needs more context-specific information to be fully relevant.
2. Correctness
(3) Score: 2. While there are no outright inaccuracies, the heavy use of placeholders makes the email feel very templated and generic rather than personalized.
(4) Score: 5. The language appears grammatically correct with no noticeable spelling errors.
(5) Score: 3. The email has a basic intro, body, conclusion structure, but each section needs much more development and detail. The body especially is lacking substance.
3. Tone and Style
(6) Score: 3. The professional and appreciative tone is acceptable for thanking someone for feedback, but it needs to be tailored more to the specific recipient and feedback context.
(7) Score: 4. The tone is mostly consistent, if a bit generic. Personalizing it further would strengthen the consistency.
(8) Score: 4. The language is clear and understandable, just very bare-bones. Expanding on the key points with more detail would improve clarity.
4. Engagement
(9) Score: 1. There is no clear call-to-action or next steps for the recipient. It's a very passive, one-way email.
(10) Score: 2. With no CTA or strong personalization, the email does little to engage the recipient or encourage a response. It reads as an obligatory acknowledgment.
5. Personalization
(11) Score: 2. Other than generic name placeholders, there is no customization to the individual recipient or their specific feedback. Much more tailoring is needed.
(12) Score: 4. The email is highly flexible with its placeholder format allowing easy customization. The issue is more that barely any customization has been done as is.
6. Input Alignment
(13) Score: 3. The email reflects parts of the YAML input like the subject line and signature, but leaves out key details that were provided, like the recipient's name or role.
(14) Score: 4. It doesn't add much if any irrelevant information beyond the YAML input, mainly because it hardly adds any information at all. More context from the input should be incorporated.
7. Edge Cases
(15) Score: 2. The ambiguous placeholders indicate the template has not been adapted to a specific context. It needs to either request more info or make reasonable assumptions.
(16) Score: 3. By being so generic, it somewhat adapts to lack of input specifics, but it really should prompt for more details to personalize the acknowledgment.
8. Compliance
(17) Score: 4. The email appears to adhere to standard feedback policies, but more specifics are needed to fully confirm compliance, especially around how the feedback will be used.
(18) Score: 5. No sensitive personal information appears to be shared, as the template is quite sparse on details overall. The personal info placeholders also indicate an awareness of this.
9. Aesthetic Quality
(19) Score: 3. The formatting is neat and clean, but very basic. Some additional visual elements, spacing, and segmenting of ideas would improve it.
(20) Score: 3. It's concise to the point of being abrupt and underdeveloped. Expanding with more context would find a better balance.
10. Similarity
(21) Score: 4. The email follows the general structure of the example quite closely, with subject/body/signature. But the example has much more fleshed out content in each section.
Overall, the key areas for improvement are:
   Adding more specific details and context aligned to the input provided
   Personalizing the content to the recipient and their feedback
   Including a call-to-action or clear next steps to better engage the recipient
   Expanding on key points to find a better balance between concision and thoroughness
   Enhancing the formatting and structure for greater visual appeal and clarity
With those adjustments, this email template could be elevated from its current generic state to an effective, impactful feedback acknowledgment.

As described herein, the first agent 208A may receive the above feedback data 216 and determine to perform another iteration of the iterative process 218 based on the value(s) indicated in the feedback data 216 not meeting or exceeding the threshold value(s) (e.g., threshold value of each metric, an aggregated threshold value, or any other suitable value). For instance, the first agent 208A may generate an updated instruction prompt 212 based on the feedback data 216 and/or accessing tool(s)/resource(s) 222. For instance, the updated instruction prompt 212 output by the first agent 208A in a subsequent iteration may include instructions as follows:
Please create a further refined **Feedback Appreciation Email Template** in **YAML** format, integrating the latest feedback to enhance personalization, detail, and engagement.
**Context Needed for a Well-Defined Email:**
   The recipient's name
   The specific feedback given by the recipient
   Detailed explanation of how the feedback will be utilized or acknowledged
   The sender's name
   The sender's contact information
**Placeholders Required:**
   subject: ‘[Recipient Name], thank you for your feedback’
   body:
      Dear [Recipient Name],
      Thank you for your valuable feedback regarding [specific feedback topic or issue].
      We genuinely appreciate your insights, and we want you to know that [specific ways the feedback will be implemented or acknowledged].
      If you have any further suggestions or questions, we would love to hear them. Would you be open to a follow-up conversation?
   signature:
      ‘Best regards,
      [Your Name]
      [Your Contact Information]’
Ensure that each section is clearly separated and that the placeholders allow for easy identification and customization. The email should be tailored to reflect the recipient's specific feedback, making it feel personalized and impactful.

An updated output from the second agent 208B, based on executing the updated instructions may include:
‘‘‘yaml
subject: ‘[Recipient Name], thank you for your feedback’
body: |
Dear [Recipient Name],
Thank you for your valuable feedback regarding [specific feedback topic or issue]. We genuinely appreciate you taking the time to share your detailed thoughts and suggestions.
Your input is important to us, and we want you to know that [specific ways the feedback will be implemented or acknowledged]. We believe that your feedback will help us [positive impact of the feedback].
If you have any further suggestions or questions, we would love to hear them. Would you be open to a brief follow-up conversation sometime next week?
signature: |
   Best regards,
   [Your Name]
   [Your Contact Information]

The feedback data 216 generated by the third agent 208C based on the updated output may include indications that the threshold value(s) are met. For instance, the updated feedback data 216 may comprise:

Here is my analysis of the latest iteration of the email template:
1. Completeness
(1) Score: 5. The email now fully addresses all key points, including a specific acknowledgment of the feedback, an expression of genuine appreciation, a detailed explanation of how the feedback will be used, and the potential positive impact.
(2) Score: 5. With the added details and context, all parts of the email are highly relevant and aligned to the purpose of acknowledging and acting on feedback.
2. Correctness
(3) Score: 4. While some placeholders remain, they are more specific and focused. Replacing them with actual details would fully personalize the email, but the guidance is clear.
(4) Score: 5. The email maintains its grammatical accuracy and avoids any spelling errors.
(5) Score: 5. The structure is clear, logical, and easy to follow, with a natural flow from appreciation to impact to next steps.
3. Tone and Style
(6) Score: 5. The tone strikes an excellent balance of genuine appreciation, professionalism, and action-orientation, well-suited for responding to feedback.
(7) Score: 5. The positive and engaging tone is consistent throughout the email.
(8) Score: 5. The language is clear, concise, and easy to understand, with enough detail to provide meaningful context without becoming verbose.
4. Engagement
(9) Score: 5. The email includes a strong call-to-action, directly inviting the recipient to continue the dialogue through a follow-up conversation.
(10) Score: 5. The personalized acknowledgments, specific impact details, and clear next steps all work to effectively engage the recipient and encourage further interaction.
5. Personalization
(11) Score: 4. The placeholders provide clear guidance for customizing the email to the specific recipient, their role, and their feedback. Filling in those details would complete the personalization.
(12) Score: 5. The template is highly adaptable to different recipients and feedback scenarios while maintaining its core structure and tone.
6. Input Alignment
(13) Score: 5. The email closely reflects the provided YAML input, incorporating all the key elements in a cohesive and relevant way.
(14) Score: 5. All the information included is directly relevant to acknowledging and responding to the feedback, without any unnecessary diversions.
7. Edge Cases
(15) Score: 4. The template provides sufficient guidance to adapt to most feedback scenarios. Some very unique edge cases may require additional customization.
(16) Score: 4. By focusing on high-level themes rather than granular specifics, the email can adapt well to minor gaps in input details. Major omissions would still require follow-up.
8. Compliance
(17) Score: 5. The email adheres to best practices for professionally and constructively responding to feedback, setting clear expectations for how it will be used.
(18) Score: 5. The template continues to avoid any sensitive personal information, keeping placeholders for details that can be filled in a compliant manner.
9. Aesthetic Quality
(19) Score: 5. The email is well-formatted, with clear paragraphs, logical grouping of ideas, and an easy-to-read structure.
(20) Score: 5. The email strikes an ideal balance of being concise but thorough, with just enough detail to convey genuine appreciation and clear next steps.
10. Similarity
(21) Score: 5. In both format and content, this email template is now highly similar to the provided example, with clear sections for appreciation, acknowledgment, impact, and continued engagement.

In summary, this latest version of the email template has addressed nearly all the previous areas for improvement. It is well-structured, highly personalized, and effectively balances appreciation with clear action items.

The only very minor refinement could be to provide a bit more guidance in the placeholders to ensure key details are not overlooked during customization. But overall, this template is thorough, engaging, and likely to have a very positive impact on recipients who have provided feedback. Great work on the revisions!

Thus, based on the updated feedback data 216, the first agent 208A may determine that the updated output meets quality standards and that the iterative process 218 may end. The first agent 208A may then provide the updated output as the instruction prompt template 220 to the user device 204 for display and/or store the updated instruction prompt (and/or any mappings) in a datastore.

FIG. 2B depicts an example environment 200B illustrating interactions of components included in the agentic collaborative framework to generate a refined instruction prompt using an iterative process 218. The example environment described in FIG. 2B is described with reference to components described herein with reference to FIGS. 1 and 2A for convenience and ease of understanding. However, the example environment 200B is not meant to be limiting and is provided for illustrative purposes only. Moreover, the components described herein are not limited to implementing the example environment 200B. Additional or fewer components may be included as part of the example environment 200B.

In particular, the illustrated example environment 200B may represent an example where the agentic collaborative framework (e.g., agentic collaborative fabric 202) is implemented at runtime and/or is integrated into a service offered to client user(s). For instance, the example environment 200B may correspond to an integration of the agentic collaborative fabric 202 with application 138 that provides a service (e.g., such as Salesforce's Prompt Builder) to client user(s). In the illustrated example environment 200B, the agentic collaborative fabric 202 may be provided as an assistant (e.g., such as a chatbot, etc.). However, it is understood that one or more components and/or operations illustrated in the example environment 200B may be implemented in other suitable environments.

In the example environment 200B, user device 204 may be associated with a client user (e.g., a user that pays to access application 138, such as a user of an enterprise, a private user, etc.). As illustrated, the example environment 200B includes agentic collaborative fabric 202, agent(s), iterative process 218 user device 204, application 138, and user interface 140. The application 138 may be configured to communicate input(s)/output(s) 234 with the agentic collaborative fabric 202, which may be executing on server(s) 102, a computing device, a cloud service, etc.

The user interface 140 may comprise one or more portions that a client user may provide input. For example, the user interface 140 may comprise a prompt template workspace 224, a preview 226 portion, and template properties 230. In some examples, each portion of the user interface 140 may provide input to and/or receive output(s) from a particular agent (e.g., first agent 208A, second agent 208B, third agent 208C, etc.). For instance, the prompt template workspace 224 may enable a user to edit a prompt template instruction. The prompt template workspace 224 may also be configured to display output(s) from the first agent 208A, such as instruction prompt template 220, as described herein. For instance, the client user may provide inputs, such as one or more input(s) 206 described in FIG. 2A herein. The client user may also provide a selection of one or more resource(s) (e.g., such as example(s), etc.). The preview 226 portion of the user interface 140 may be configured to receive and display output(s) from the second agent 208B. For instance, the response 228 subsection of the preview 226 portion illustrates an example of instructions that may be displayed to a client user prior to the iterative process 218 being performed. As illustrated, the client user may provide input(s) including whether to view resolution details, selection of a recipient, and/or selection of a language. The template properties 230 may be configured to receive input(s) via the conversation preview 232 chat screen and provide the input(s) to the third agent 208C. For instance, template properties 230 may be included as part of a configuration portion of the user interface 140. The template properties 230 may provide input(s) including one or more settings associated with the application 138. For instance, the client user may select one or more model type(s) and/or model(s) for use with the agentic collaborative fabric 202. The conversation preview 232 window may represent a chat window of an assistant (e.g., artificial intelligence assistant, generative AI assistance, etc.) that communicates with the third agent 208C. The client user may provide input(s) within the chat box (illustrated as including text, such as “describe you task or ask a question”). For instance, the client user may provide an input that comprises “create a feedback email for customers.” The input(s) from each portion of the user interface 140 may be provided to the agentic collaborative fabric 202, which may perform the iterative process 218 and provide output(s) to respective portions of the user interface 140. In the example environment 200B, the client user may view the output(s) via the response 228 window and provide additional instructions for refinement. In the example environment, the agentic collaborative framework is configured to remember the previous input(s) received from a client user, thereby enabling the client user to run multiple iterations of the iterative process 218 and generate high-quality instruction prompts faster.

As described herein, the example environment 200B further includes storing pre-configured data, such as system prompt(s) (illustrated as first system prompt 210A, second system prompt 210B, third system prompt 210C), quality criteria 206A, example(s) 206N, instruction prompt data 124, etc. in a database of the system. The pre-configured data may be mapped to particular task(s) and/or particular model(s). Accordingly, when a client user provides a query, a selection of a type of task (e.g., draft an email, extract text, etc.) and/or selection of a model type as input(s), the system may retrieve and utilize the corresponding pre-configured data, thereby simplifying and streamlining user experience. The client user may further refine the output(s) of the agentic collaborative fabric 202 (e.g., an instruction prompt template that is output after performing the iterative process 218 a first time). For instance, the client user may provide second input to the conversation preview 232, such as “make the tone of the email more professional.” The second input is provided to both the first agent 208A and third agent 208C. In this example, the third agent 208C may adjust one or more metrics of the quality criteria associated with evaluating email templates to incorporate the second input. As an example, and not by way of limitation, the third agent 208C may increase the threshold score associated with a “tone” metric of the quality metrics and/or provide other adjustments. The first agent 208A may receive the second input and/or the previous input(s) (e.g., original query, first instruction prompt template output, first examples, first system prompt, etc.). In an example, the agentic collaborative fabric 202 may remember the previous input(s) received from the application 138, such that the first agent 208A may simply receive the second input. The agentic collaborative fabric 202 may perform a second iteration of the iterative process 218 and provide output(s) to the user interface 140. The client user may continue to make minor refinements via the conversation preview 232, thereby performing additional iterations of the iterative process 218.

In some examples, the techniques discussed herein may provide a novel process to enable multiple agents to perform an iterative process 218, thereby reducing the amount of time it would take for a client user to perform a task (e.g., create an email, extract text, etc.) and/or a prompt engineer to create an instruction prompt template for a particular task.

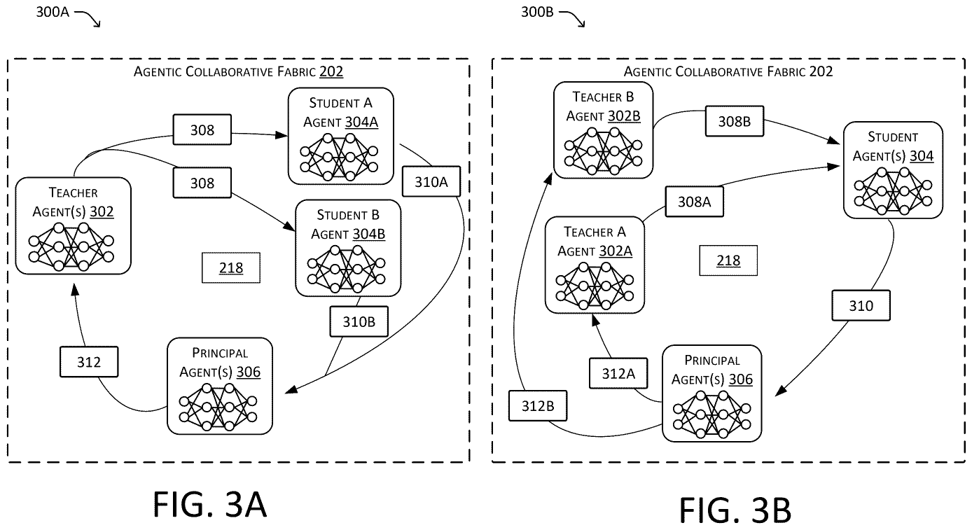

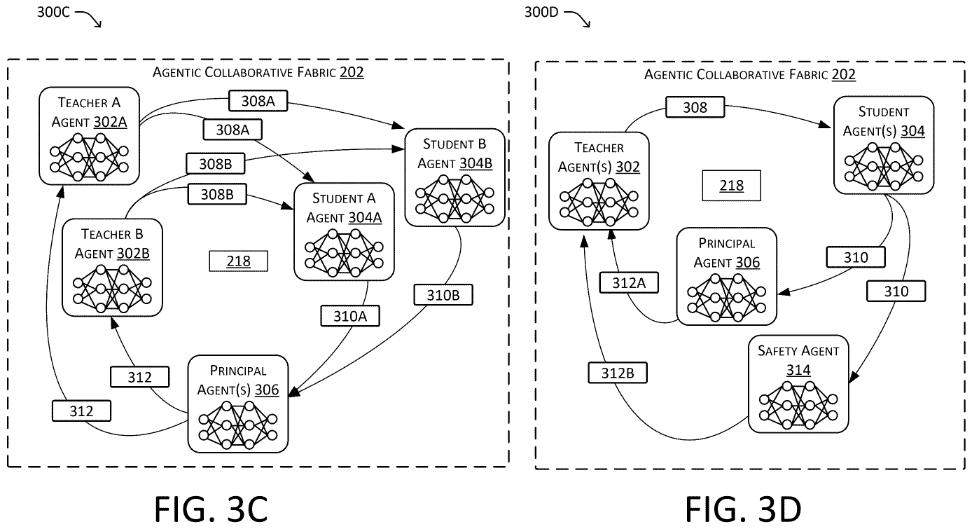

FIGS. 3A-3D illustrate example architectures of the agentic collaborative fabric 202, according to the techniques described herein. The example architectures described in FIGS. 3A-3D are described with reference to components described herein with reference to FIGS. 1-2B for convenience and ease of understanding. However, the example architectures described in FIGS. 3A-3D are not meant to be limiting and are provided for illustrative purposes only. Moreover, the components described herein are not limited to implementing the example architectures illustrated in FIGS. 3A-3D. Additional architectures are contemplated that may incorporate additional or fewer agents than the architectures described herein. Accordingly, unlike existing generative machine learned models, the architectures described herein may implement the iterative process 218 to utilize feedback loops that provide improved output(s) in a cost-effective and scalable way.

FIG. 3A illustrates an example architecture 300A associated with generating an instruction prompt template using at least two student agents. The example architecture 300A includes agentic collaborative fabric 202 and iterative process 218, as described herein. The example architecture 300A further includes teacher agent(s) 302, student A agent 304A, student B agent 304B, and principal agent(s) 306. Teacher agent(s) 302 may represent at least one first agent 208A, as described herein. Student A agent 304A may comprise a first LLM of a first type configured to perform the role of the student agent. Student B agent 304B may comprise a second LLM of a second type configured to perform the role of the student agent. Accordingly, student A agent 304A and student B agent 304B may comprise different types of LLMs to generate an instruction prompt template 220 that provides similar output(s) 214 across the different LLMs.

As illustrated in FIG. 3A, the iterative process 218 may be performed, where the teacher agent(s) 302 may provide an input 308 to student A agent 304A and student B agent 304B. The input 308 may comprise the same instruction prompt for both student agents. Student A agent 304A may generate and provide a first output 310A to the principal agent(s) 306 and student B agent 304B may execute the input 308 and provide a second output 310B to the principal agent(s) 306. In this example, the principal agent(s) 306 may generate feedback data 312 based on both the first output 310A and the second output 310B, where the feedback data 312 comprises instructions to help the teacher agent(s) 302 converge on an instruction prompt that, when executed by the student A agent 304A and the student B agent 304B, produce similar output(s) that meet or exceed the threshold quality criteria metrics.

FIG. 3B illustrates an example diverse learning architecture 300B associated with generating an instruction prompt template using at least two teacher agents. The example diverse learning architecture 300B includes agentic collaborative fabric 202 and iterative process 218, as described herein. The example diverse learning architecture 300B further includes teacher A agent 302A, teacher B agent 302B, student agent(s) 304, and principal agent(s) 306. Teacher A agent 302A may comprise a first LLM of a first type configured to perform the role of the teacher agent. Teacher B agent 302B may comprise a second LLM of a second type configured to perform the role of the teacher agent. Accordingly, the diverse learning architecture 300B may be utilized to identify which teacher agent provides and/or generates the highest quality instruction prompt for a particular student agent 304 of a particular LLM type. In some examples, the system may store pairings between the LLMs utilized by the teacher agent and the LLM type of the student agent for use in generating recommended models and/or automatically selecting the model type based on a user input.

As illustrated in FIG. 3B, the iterative process 218 may be performed, where the teacher A agent 302A may provide a first input 308A to the student agent(s) 304. Teacher B agent 302B may provide a second input 308B to the student agent(s) 304. The first input 308A may comprise a first instruction prompt with instructions associated with executing a task and the second input 308B may comprise a second instruction prompt with one or more different instructions. In some examples, the first input 308A may be associated with performing a first task (e.g., generating an email of a first email type) and the second input 308B may be associated with performing a second task (e.g., generating an email of a second email type). The student agent(s) 304 may execute the first input 308A and the second input 308B and provide output 310 to the principal agent(s) 306. In an example, the student agent(s) 304 may provide separate output(s) to the principal agent(s) 306. In an example, the student agent(s) 304 may provide an aggregated output to the principal agent(s), where the aggregated output(s) indicate the teacher agent associated with a corresponding output (e.g., output A is generated based on input 308A, etc.). The principal agent(s) 306 may generate feedback data 312 based on the output(s) 310. In some examples, the feedback data 312 provided to teacher A agent 302A may comprise the same feedback as the feedback data provided to teacher B agent 302B. Accordingly, the techniques may enable the student agent(s) 304 to be trained to be more diverse in solving different types of tasks (e.g., multiple types of emails, etc.).

FIG. 3C illustrates an example grid search architecture 300C associated with generating an instruction prompt template using at least two student agents and/or at least two teacher agents. The example grid search architecture 300C may include agentic collaborative fabric 202, iterative process 218, teacher A agent 302A, teacher B agent 302B, student A agent 304A, student B agent 304B, and principal agent(s) 306, as described herein. Accordingly, the grid search architecture 300C may be utilized to identify which teacher agent provides and/or generates the highest quality instruction prompt for a particular student agent 304 of a particular LLM type. In some examples, the system may store pairings between the LLMs utilized by the teacher agent and the LLM type of the student agent for use in generating recommended models and/or automatically selecting the model type based on a user input.

As illustrated in FIG. 3C, the iterative process 218 may be performed, where the teacher A agent 302A may provide a first input 308A to student A agent 304A and student B agent 304B. Teacher B agent 302B may provide a second input 308B to student A agent 304A and student B agent 304B. The first input 308A may comprise a first instruction prompt with instructions associated with executing a task and the second input 308B may comprise a second instruction prompt associated with executing the same task. Student A agent 304A may execute the first input 308A and the second input 308B and provide a first output 310A to the principal agent(s) 306. The first output 310A may aggregate the results of executing the first input 308A and the second input 308B. Student B agent 304B may execute the first input 308A and the second input 308B and provide a second output 310B to the principal agent(s) 306. The second output 310B may aggregate the results of executing the first input 308A and the second input 308B. The principal agent(s) 306 may generate first feedback data 312 based on the first output 310A and the second output 310B. In an example, the feedback data 312 may include portions of the outputs associated with the higher scoring output. For instance, where a first portion of the first output 310A associated with the first input 308A comprises an average score that is greater than the average score of the first portion of the second output 310B that is generated based on the first input 308A, the feedback data 312 may include the first portion of the first output 310A as an example. Similarly, where a second portion of the first output 310A that is generated based on the second input 308B comprises an average score that is lower than the average score of the second portion of the second output 310B that is generated based on the second input 308B, the feedback data 312 may include the second portion of the second output 310B as an example. In the next iteration of the iterative process, each teacher agent may utilize the example(s) when generating updated input(s). Accordingly, the techniques may identify pairings between LLM types of the teacher agent(s) and LLM types of the student agent(s) that produce the highest quality instruction prompt templates.

FIG. 3D illustrates an example architecture 300D associated with generating an instruction prompt template using at least two principal agents. The example architecture 300D may include agentic collaborative fabric 202, iterative process 218, teacher agent(s) 302, student agent(s) 304, principal agent 306, as described herein. The example architecture further includes safety agent 314. Safety agent 314 may represent a second agent configured to perform a principal agent role associated with a different set of quality criteria and/or trained to evaluate a particular type of quality criteria. For instance, principal agent 306 may comprise a first LLM trained to evaluate security quality criteria of the output(s) 310 and safety agent 314 may comprise a second LLM trained to evaluate safety quality criteria of the output(s) 310. The first LLM and the second LLM may comprise LLMs of a same type or different types. Accordingly, the example architecture 300D may be utilized to generate high-quality instruction prompt templates that meet multiple sets of quality criteria and/or policies of an organization.

As illustrated in FIG. 3D, the iterative process 218 may be performed, where the teacher agent(s) 302 may provide an input 308 to student agent(s) 304. Student agent(s) 304 may generate and provide output(s) 310 to the principal agent 306 and safety agent 314. As noted above, the output(s) 310. The principal agent 306 may generate first feedback data 312A based on both the first output 310, a first set of quality criteria, and/or accessing first tool(s)/resource(s) 222. The first feedback data 312A may comprise first instructions to help the teacher agent(s) 302 generate an instruction prompt that meets or exceeds the threshold values of the first set of quality criteria metrics. The safety agent 314 may generate second feedback data 312B based on the output 310, a second set of quality criteria, and/or accessing second tool(s)/resource(s) 222. The second feedback data 312B may comprise second instructions to help the teacher agent(s) 302 generate an instruction prompt that meets or exceeds the threshold values of the second set of quality criteria metrics. In some examples, the first feedback data 312A and second feedback data 312B may be aggregated and provided as an aggregated input to the teacher agent(s). The teacher agent(s) 302 may utilize the aggregated feedback data to determine whether to iterate again and/or generate updated instruction prompts. Accordingly, the techniques may enable the iterative process 218 to be performed on multiple sets of quality criteria that may be customized (to a particular department, organization, etc.) to produce high-quality instruction prompts according to the policies of a user.

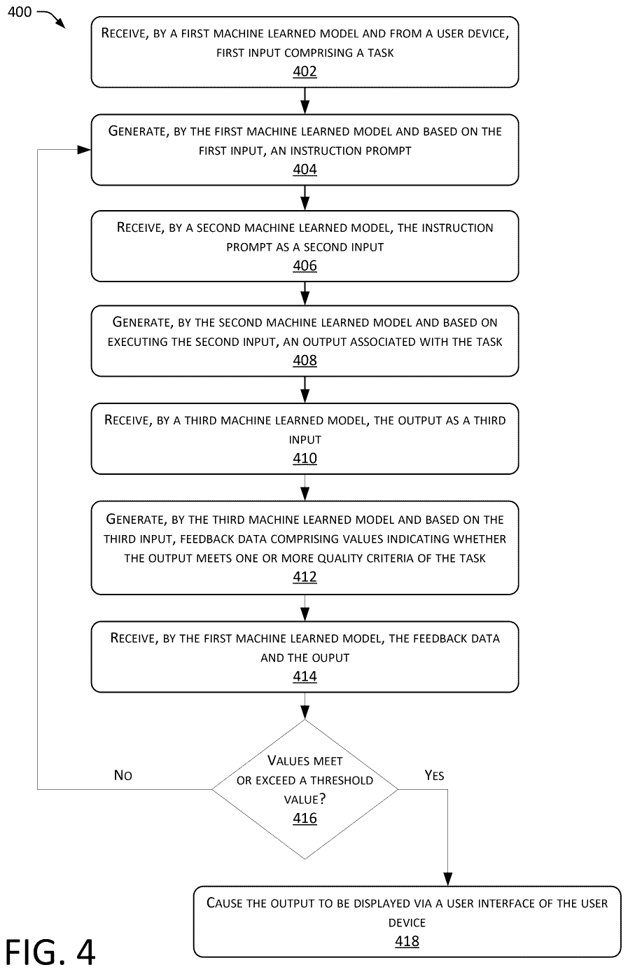

FIG. 4 illustrates a flow diagram of an example process 400 for generating a refined instruction prompt using an iterative process, according to the techniques described herein. The process 400 illustrated in FIG. 4 is described with reference to components described herein with reference FIGS. 1-3D for convenience and ease of understanding. However, the processes illustrated in FIG. 4 is not limited to being performed using the components described herein. Moreover, the components described herein are not limited to performing the process 400 illustrated in FIG. 4.

Process 400 is illustrated as collections of blocks in a logical flow diagram, representing sequences of operations, some or all of which can be implemented in hardware, software, or a combination thereof. In the context of software, the blocks represent computer-executable instructions stored on one or more computer-readable media that, when executed by one or more processors, perform the recited operations. Generally, computer-executable instructions include routines, programs, objects, components, encryption, deciphering, compressing, recording, data structures, and the like that perform particular functions or implement particular abstract data types. The order in which the operations are described should not be construed as a limitation. Any number of the described blocks can be combined in any order and/or in parallel to implement the processes, or alternative processes, and not all of the blocks need to be executed in all examples. For discussion purposes, the processes herein are described in reference to the frameworks, architectures and environments described in the examples herein, although the processes may be implemented in a wide variety of other frameworks, architectures or environments.

At operation 402, the process 400 can include receiving, by a first machine learned model and from a user device, first input comprising a task. In some examples, the task comprises instructions to generate the instruction prompt and the first input further comprises one or more of: task instructions associated with the task; example outputs associated with the task; quality criteria associated with evaluating the task; or a predefined system prompt defining a role associated with the first machine learned model. For instance, the first input may correspond to input(s) 206. In some examples, wherein one or more of the first machine learned model may comprise a stateless large language model. For instance, the first machine learned model may correspond to a first agent (e.g., such as a teacher agent).

At operation 404, the process 400 can include generating, by the first machine learned model and based on the first input, an instruction prompt. For instance, the first machine learned model may generate, based on input(s) 206 an instruction prompt comprising instructions to execute the task.

At operation 406, the process 400 can include receiving, by a second machine learned model, the instruction prompt as a second input. In some examples, the second input further comprises a predefined system prompt defining a role of the second machine learned model. For instance, the predefined system prompt may configure the second machine learned model as a student agent.

At operation 408, the process 400 can include generating, by the second machine learned model and based on executing the second input, an output associated with the task. In some examples, generating, by the second machine learned model, the output associated with the task comprises: identifying, based on the second input, an instruction to access task data from one or more databases; querying the one or more databases for the task data; and generating the output based on the task data.

At operation 410, the process 400 can include receiving by a third machine learned model, the output as a third input. In some examples, the third input further comprises quality criteria associated with evaluating the task and a predefined system prompt defining a role associated with the third machine learned model. For instance, the predefined system prompt may configure the third machine learned model as a principal agent. In some examples, the third input may comprise example output(s) associated with the task. For instance, where the task is to draft a customer appreciation email, the example outputs may comprise examples of customer appreciation emails that meet or exceed the quality criteria.

At operation 412, the process 400 can include generating by the third machine learned model and based on the third input, feedback data comprising value(s) indicating whether the output meets one or more quality criteria of the task. In some examples, generating, by the third machine learned model, the feedback data is further based on: example outputs associated with the task; and result data associated with an external evaluation tool.

At operation 414, the process 400 can include receiving, by the first machine learned model, the feedback data and the output. In some examples, the first machine learned model may access the previous instruction prompt generated.

At operation 416, the process 400 can include determining whether the value(s) meet or exceed a threshold value. For instance, the process may determine whether a majority of individual score(s) exceed the threshold value(s) set for each metric in the quality criteria. In some examples, the process may determine that an average score of the metrics exceeds a threshold value. In some examples, the process may determine that a percentage of the score(s) (e.g., 100%, 90%, 80%, etc.) meet or exceed the threshold value(s) set for each metric.

Where the value(s) are less than the threshold value (416—NO), the process may return to operation 404 and another iteration of the iterative process 218 may be performed, as described herein. For instance, the process may include generating, by the first machine learned model, an updated instruction prompt based on the feedback data. In some examples, wherein generating the updated instruction prompt is further based on: retrieving, by the first machine learned model, knowledge data associated with the task; and generating the updated instruction prompt based on the instruction prompt, the knowledge data, and the feedback data.

In some examples, such as where the process returns to operation 404, the process further includes: receiving, by the second machine learned model, the second instruction prompt as a fourth input; generating, by the second machine learned model and based on executing the fourth input, a second output associated with the task; receiving, by the third machine learned model, the second output as a fifth input; generating, by the third machine learned model and based on the fifth input, second feedback data comprising second values indicating whether the second output meets the one or more quality criteria of the task; receiving, by the first machine learned model, the second feedback data and the second output; and based on the second feedback data indicating the second values meet or exceed the threshold value, causing the second output to be displayed via a user interface of the user device.

Where the value(s) meet or exceed the threshold value (416—YES), the process may proceed to 418. At operation 418, the process 400 can include causing the output to be displayed via a user interface of the user device. In some examples, where the feedback data indicates the values meet or exceed the threshold value, the process may include at least one of: storing, in a database, the output as a template associated with the task; associating the output with a service, the output being accessible as a prompt for a subset of users of an organization utilizing the service; or storing, in the database, the output as the template associated with the task and an indication of a type of machine learned model associated with the second machine learned model.

In an example, prior to receiving the first input, the process may include storing, in a database, one or more system prompts configured to define one or more roles of machine learned models; and storing, in the database, one or more sets of quality criteria in association with one or more tasks, the one or more sets of quality criteria being accessed by the third machine learned model in response to receiving the output.

In some examples, the first machine learned model may comprise multiple first models configured to perform a first role. In this example, the multiple first models may be configured to provide instruction prompts as the second input to the second machine learned model and receive the feedback data from the third machine learned model, the feedback data further comprising an instruction prompt associated with a highest scoring output of the second machine learned model to be displayed or used in generating updated instruction prompts.

In some examples, the second machine learned model comprises multiple second models of different types configured to perform a second role. In this example, the multiple second models may include a first model of a first type and a second model of a second type, the first model and the second model being configured to receive the instruction prompt from the first machine learned model and provide a first output from the first model and a second output from the second model to the third machine learned model as the third input used to generate the feedback data.

In some examples, the third machine learned model comprises multiple third models configured to perform a third role. In this example, the multiple third models may be configured to provide the feedback data, the feedback data from the multiple third models being aggregated and provided as an aggregated input to the first machine learned model.

In some examples, the process may be integrated with an application. For instance, the process may include receiving, by the third machine learned model, sixth input comprising a change to the one or more quality criteria associated with the task; storing, by the third machine learned model, updated quality criteria comprising the change; generating, by the third machine learned model and based on the sixth input, third feedback data comprising instructions associated with updating the second instruction prompt; receiving, by the first machine learned model, seventh input comprising the third feedback data, the second output, the first input, and a system prompt; generating, by the first machine learned model a third instruction prompt based on the seventh input; receiving, by the second machine learned model, the third instruction prompt as an eighth input; generating, by the second machine learned model and based on executing the eighth input, a third output associated with the task; receiving, by the third machine learned model, the third output as a ninth input; generating, by the third machine learned model and based on the third input, fourth feedback data comprising third values indicating whether the third output meets the updated quality criteria of the task; receiving, by the first machine learned model, the fourth feedback data and the third output; and at least one of: based on the feedback data indicating the third values are below the threshold value, generating an updated instruction prompt using the feedback data; or based on the fourth feedback data indicating the third values meet or exceed the threshold value, causing the third output to be displayed via the user interface of the user device.

### Example Clauses

A. A method comprising: receiving, by a first machine learned model and from a user device, first input comprising a task; generating, by the first machine learned model and based on the first input, an instruction prompt; receiving, by a second machine learned model, the instruction prompt as a second input; generating, by the second machine learned model and based on executing the second input, an output associated with the task; receiving, by a third machine learned model, the output as a third input; generating, by the third machine learned model and based on the third input, feedback data comprising values indicating whether the output meets one or more quality criteria of the task; receiving, by the first machine learned model, the feedback data and the output; and at least one of: based on the feedback data indicating the values are below a threshold value, generating an updated instruction prompt using the feedback data; or based on the feedback data indicating the values meet or exceed the threshold value, causing the output to be displayed via a user interface of the user device.
B. The method of paragraph A, wherein the task comprises instructions to generate the instruction prompt and the first input further comprises one or more of: task instructions associated with the task; example outputs associated with the task; quality criteria associated with evaluating the task; or a predefined system prompt defining a role associated with the first machine learned model.
C. The method of either paragraph A or B, wherein one or more of the first machine learned model or the second machine learned model comprise stateless large language models.
D. The method of any one of paragraphs A-C, wherein generating the updated instruction prompt is further based on: retrieving, by the first machine learned model, knowledge data associated with the task; and generating the updated instruction prompt based on the instruction prompt, the knowledge data, and the feedback data.
E. The method of any one of paragraphs A-D, wherein the second input further comprises a predefined system prompt defining a role of the second machine learned model, and wherein generating, by the second machine learned model, the output associated with the task comprises: identifying, based on the second input, an instruction to access task data from one or more databases; querying the one or more databases for the task data; and generating the output based on the task data.
F. The method of any one of paragraphs A-E, wherein the third input further comprises quality criteria associated with evaluating the task and a predefined system prompt defining a role associated with the third machine learned model, and wherein generating, by the third machine learned model, the feedback data is further based on: example outputs associated with the task; and result data associated with an external evaluation tool.
G. The method of any one of paragraphs A-F, wherein prior to receiving the first input, the method further comprises: storing, in a database, one or more system prompts configured to define one or more roles of machine learned models; and storing, in the database, one or more sets of quality criteria in association with one or more tasks, the one or more sets of quality criteria being accessed by the third machine learned model in response to receiving the output.
H. The method of any one of paragraphs A-G, wherein the feedback data indicates the values meet or exceed the threshold value, further comprising at least one of: storing, in a database, the output as a template associated with the task; associating the output with a service, the output being accessible as a prompt for a subset of users of an organization utilizing the service; or storing, in the database, the output as the template associated with the task and an indication of a type of machine learned model associated with the second machine learned model.
I. The method of any one of paragraphs A-H, wherein at least one of: the first machine learned model comprises multiple first models configured to perform a first role; the second machine learned model comprises multiple second models of different types configured to perform a second role; or the third machine learned model comprises multiple third models configured to perform a third role.
J. A system comprising: one or more processors; and one or more non-transitory computer-readable media that, when executed by the one or more processors, cause the one or more processors to perform operations comprising: receiving, by a first machine learned model and from a user device, first input comprising a task; generating, by the first machine learned model and based on the first input, an instruction prompt; receiving, by a second machine learned model, the instruction prompt as a second input; generating, by the second machine learned model and based on executing the second input, an output associated with the task; receiving, by a third machine learned model, the output as a third input; generating, by the third machine learned model and based on the third input, feedback data comprising values indicating whether the output meets one or more quality criteria of the task; receiving, by the first machine learned model, the feedback data and the output; and based on the feedback data indicating the values are below a threshold value, generating a second instruction prompt using the feedback data.
K. The system of paragraph J, wherein the task comprises instructions to generate the instruction prompt and the first input further comprises one or more of: task instructions associated with the task; example outputs associated with the task; or a predefined system prompt defining a role associated with the first machine learned model.
L. The system of either paragraph J or K, wherein generating the second instruction prompt is further based on: retrieving, by the first machine learned model, knowledge data associated with the task; and generating the second instruction prompt based on the instruction prompt, the knowledge data, and the feedback data.
M. The system of any one of paragraphs J-L, wherein the second input further comprises a predefined system prompt defining a role of the second machine learned model, and wherein generating, by the second machine learned model, the output associated with the task comprises: identifying, based on the second input, an instruction to access task data from a database of the system; querying the database for the task data; and generating the output based on the task data.
N. The system of any one of paragraphs J-M, wherein the third input further comprises a predefined system prompt defining a role associated with the third machine learned model, and wherein generating, by the third machine learned model, the feedback data is further based on: receiving the one or more quality criteria based on the task; accessing example outputs associated with the task; or receiving result data associated with an external evaluation tool.
O. The system of any one of paragraphs J-N, wherein prior to receiving the first input, the operations further comprise: storing, in a database, one or more system prompts configured to define one or more roles of machine learned models; and storing, in the database, one or more sets of quality criteria in association with one or more tasks, the one or more sets of quality criteria being accessed by the third machine learned model in response to receiving the output.
P. The system of any one of paragraphs J-O, wherein the operations further comprise: receiving, by the second machine learned model, the second instruction prompt as a fourth input; generating, by the second machine learned model and based on executing the fourth input, a second output associated with the task; receiving, by the third machine learned model, the second output as a fifth input; generating, by the third machine learned model and based on the fifth input, second feedback data comprising second values indicating whether the second output meets the one or more quality criteria of the task; receiving, by the first machine learned model, the second feedback data and the second output; and based on the second feedback data indicating the second values meet or exceed the threshold value, causing the second output to be displayed via a user interface of the user device.
Q. The system of any one of paragraphs J-P, the operations further comprising: receiving, by the third machine learned model, sixth input comprising a change to the one or more quality criteria associated with the task; storing, by the third machine learned model, updated quality criteria comprising the change; generating, by the third machine learned model and based on the sixth input, third feedback data comprising instructions associated with updating the second instruction prompt; receiving, by the first machine learned model, seventh input comprising the third feedback data, the second output, the first input, and a system prompt; generating, by the first machine learned model a third instruction prompt based on the seventh input; receiving, by the second machine learned model, the third instruction prompt as an eighth input; generating, by the second machine learned model and based on executing the eighth input, a third output associated with the task; receiving, by the third machine learned model, the third output as a ninth input; generating, by the third machine learned model and based on the third input, fourth feedback data comprising third values indicating whether the third output meets the updated quality criteria of the task; receiving, by the first machine learned model, the fourth feedback data and the third output; and at least one of: based on the feedback data indicating the third values are below the threshold value, generating an updated instruction prompt using the feedback data; or based on the fourth feedback data indicating the third values meet or exceed the threshold value, causing the third output to be displayed via the user interface of the user device.
R. The system of any one of paragraphs J-Q, wherein at least one of: the first machine learned model comprises multiple first models configured to perform a first role; the second machine learned model comprises multiple second models of different types configured to perform a second role; or the third machine learned model comprises multiple third models configured to perform a third role.
S. The system of any one of paragraphs J-R, wherein at least one of: the first machine learned model comprises the multiple first models configured to provide instruction prompts as the second input to the second machine learned model and receive the feedback data from the third machine learned model, the feedback data further comprising an instruction prompt associated with a highest scoring output of the second machine learned model to be displayed or used in generating updated instruction prompts; the second machine learned model comprises the multiple second models including a first model of a first type and a second model of a second type, the first model and the second model being configured to receive the instruction prompt from the first machine learned model and provide a first output from the first model and a second output from the second model to the third machine learned model as the third input used to generate the feedback data; or the third machine learned model comprises the multiple third models configured to provide the feedback data, the feedback data from the multiple third models being aggregated and provided as an aggregated input to the first machine learned model.
T. One or more non-transitory computer-readable media storing instructions executable by one or more processors, wherein the instructions, when executed, cause the one or more processors to perform operations comprising: receiving, by a first machine learned model and from a user device, first input comprising a task; generating, by the first machine learned model and based on the first input, an instruction prompt; receiving, by a second machine learned model, the instruction prompt as a second input; generating, by the second machine learned model and based on executing the second input, an output associated with the task; receiving, by a third machine learned model, the output as a third input; generating, by the third machine learned model and based on the third input, feedback data comprising values indicating whether the output meets one or more quality criteria of the task; receiving, by the first machine learned model, the feedback data and the output; and based on the feedback data indicating the values meet or exceed a threshold value, causing the output to be displayed via a user interface of the user device.

While the example clauses described above are described with respect to one particular implementation, it should be understood that, in the context of this document, the content of the example clauses can also be implemented via a method, device, system, a computer-readable medium, and/or another implementation. Additionally, any of examples A-T may be implemented alone or in combination with any other one or more of the examples A-T.

### CONCLUSION

While one or more examples of the techniques described herein have been described, various alterations, additions, permutations and equivalents thereof are included within the scope of the techniques described herein. For example, articles such as “a,” “an,” or “the” should be construed as being one or more elements. Moreover, a set should be construed as 0, 1, or more elements, since a set may be an empty set (e.g., a set comprising zero elements), a singleton (e.g., a set comprising a single element), or a set comprising multiple elements (e.g., a set comprising two or more elements). Moreover, it should be appreciated that the term “subset” describes a proper subset. A proper subset of set is a portion of the set that is not equal to the set. For example, if elements A, B, and C belong to a first set, a subset including elements A and B is a proper subset of the first set. However, a subset including elements A, B, and C is not a proper subset of the first set.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types. Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

1. A method comprising:
receiving, by a first machine learned model and from a user device, first input comprising a task;
generating, by the first machine learned model and based on the first input, an instruction prompt;
receiving, by a second machine learned model, the instruction prompt as a second input;
generating, by the second machine learned model and based on executing the second input, an output associated with the task;
receiving, by a third machine learned model, the output as a third input;
generating, by the third machine learned model and based on the third input, feedback data comprising values indicating whether the output meets one or more quality criteria of the task;
receiving, by the first machine learned model, the feedback data and the output; and
at least one of:
based on the feedback data indicating the values are below a threshold value, generating an updated instruction prompt using the feedback data; or
based on the feedback data indicating the values meet or exceed the threshold value, causing the output to be displayed via a user interface of the user device.

2. The method of claim 1, wherein the task comprises instructions to generate the instruction prompt and the first input further comprises one or more of:
task instructions associated with the task;
example outputs associated with the task;
quality criteria associated with evaluating the task; or
a predefined system prompt defining a role associated with the first machine learned model.

3. The method of claim 1, wherein one or more of the first machine learned model or the second machine learned model comprise stateless large language models.

4. The method of claim 1, wherein generating the updated instruction prompt is further based on:
retrieving, by the first machine learned model, knowledge data associated with the task; and
generating the updated instruction prompt based on the instruction prompt, the knowledge data, and the feedback data.

5. The method of claim 1, wherein the second input further comprises a predefined system prompt defining a role of the second machine learned model, and wherein generating, by the second machine learned model, the output associated with the task comprises:
identifying, based on the second input, an instruction to access task data from one or more databases;
querying the one or more databases for the task data; and
generating the output based on the task data.

6. The method of claim 1, wherein the third input further comprises quality criteria associated with evaluating the task and a predefined system prompt defining a role associated with the third machine learned model, and wherein generating, by the third machine learned model, the feedback data is further based on:
example outputs associated with the task; and
result data associated with an external testing tool.

7. The method of claim 1, wherein prior to receiving the first input, the method further comprises:
storing, in a database, one or more system prompts configured to define one or more roles of machine learned models; and
storing, in the database, one or more sets of quality criteria in association with one or more tasks, the one or more sets of quality criteria being accessed by the third machine learned model in response to receiving the output.

8. The method of claim 1, wherein the feedback data indicates the values meet or exceed the threshold value, further comprising at least one of:
storing, in a database, the output as a template associated with the task;
associating the output with a service, the output being accessible as a prompt for a subset of users of an organization utilizing the service; or
storing, in the database, the output as the template associated with the task and an indication of a type of machine learned model associated with the second machine learned model.

9. The method of claim 1, wherein at least one of:
the first machine learned model comprises multiple first models configured to perform a first role;
the second machine learned model comprises multiple second models of different types configured to perform a second role; or
the third machine learned model comprises multiple third models configured to perform a third role.

10. A system comprising:
one or more processors; and
one or more non-transitory computer-readable media that, when executed by the one or more processors, cause the one or more processors to perform operations comprising:
receiving, by a first machine learned model and from a user device, first input comprising a task;
generating, by the first machine learned model and based on the first input, an instruction prompt;
receiving, by a second machine learned model, the instruction prompt as a second input;
generating, by the second machine learned model and based on executing the second input, an output associated with the task;
receiving, by a third machine learned model, the output as a third input;
generating, by the third machine learned model and based on the third input, feedback data comprising values indicating whether the output meets one or more quality criteria of the task;
receiving, by the first machine learned model, the feedback data and the output; and
based on the feedback data indicating the values are below a threshold value, generating a second instruction prompt using the feedback data.

11. The system of claim 10, wherein the task comprises instructions to generate the instruction prompt and the first input further comprises one or more of:
task instructions associated with the task;
example outputs associated with the task; or
a predefined system prompt defining a role associated with the first machine learned model.

12. The system of claim 10, wherein generating the second instruction prompt is further based on:
retrieving, by the first machine learned model, knowledge data associated with the task; and
generating the second instruction prompt based on the instruction prompt, the knowledge data, and the feedback data.

13. The system of claim 10, wherein the second input further comprises a predefined system prompt defining a role of the second machine learned model, and wherein generating, by the second machine learned model, the output associated with the task comprises:
identifying, based on the second input, an instruction to access task data from a database of the system;
querying the database for the task data; and
generating the output based on the task data.

14. The system of claim 10, wherein the third input further comprises a predefined system prompt defining a role associated with the third machine learned model, and wherein generating, by the third machine learned model, the feedback data is further based on:
receiving the one or more quality criteria based on the task;
accessing example outputs associated with the task; or
receiving result data associated with an external evaluation tool.

15. The system of claim 10, wherein prior to receiving the first input, the operations further comprise:
storing, in a database, one or more system prompts configured to define one or more roles of machine learned models; and
storing, in the database, one or more sets of quality criteria in association with one or more tasks, the one or more sets of quality criteria being accessed by the third machine learned model in response to receiving the output.

16. The system of claim 10, the operations further comprising:
receiving, by the second machine learned model, the second instruction prompt as a fourth input;
generating, by the second machine learned model and based on executing the fourth input, a second output associated with the task;
receiving, by the third machine learned model, the second output as a fifth input;
generating, by the third machine learned model and based on the fifth input, second feedback data comprising second values indicating whether the second output meets the one or more quality criteria of the task;
receiving, by the first machine learned model, the second feedback data and the second output; and
based on the second feedback data indicating the second values meet or exceed the threshold value, causing the second output to be displayed via a user interface of the user device.

17. The system of claim 16, the operations further comprising:
receiving, by the third machine learned model, sixth input comprising a change to the one or more quality criteria associated with the task;
storing, by the third machine learned model, updated quality criteria comprising the change;
generating, by the third machine learned model and based on the sixth input, third feedback data comprising instructions associated with updating the second instruction prompt;
receiving, by the first machine learned model, seventh input comprising the third feedback data, the second output, the first input, and a system prompt;
generating, by the first machine learned model a third instruction prompt based on the seventh input;
receiving, by the second machine learned model, the third instruction prompt as an eighth input;
generating, by the second machine learned model and based on executing the eighth input, a third output associated with the task;
receiving, by the third machine learned model, the third output as a ninth input;
generating, by the third machine learned model and based on the third input, fourth feedback data comprising third values indicating whether the third output meets the updated quality criteria of the task;
receiving, by the first machine learned model, the fourth feedback data and the third output; and
at least one of:
based on the feedback data indicating the third values are below the threshold value, generating an updated instruction prompt using the feedback data; or
based on the fourth feedback data indicating the third values meet or exceed the threshold value, causing the third output to be displayed via the user interface of the user device.

18. The system of claim 10, wherein at least one of:
the first machine learned model comprises multiple first models configured to perform a first role;
the second machine learned model comprises multiple second models of different types configured to perform a second role; or
the third machine learned model comprises multiple third models configured to perform a third role.

19. The system of claim 18, wherein at least one of:
the first machine learned model comprises the multiple first models configured to provide instruction prompts as the second input to the second machine learned model and receive the feedback data from the third machine learned model, the feedback data further comprising an instruction prompt associated with a highest scoring output of the second machine learned model to be displayed or used in generating updated instruction prompts;
the second machine learned model comprises the multiple second models including a first model of a first type and a second model of a second type, the first model and the second model being configured to receive the instruction prompt from the first machine learned model and provide a first output from the first model and a second output from the second model to the third machine learned model as the third input used to generate the feedback data; or
the third machine learned model comprises the multiple third models configured to provide the feedback data, the feedback data from the multiple third models being aggregated and provided as an aggregated input to the first machine learned model.

20. One or more non-transitory computer-readable media storing instructions executable by one or more processors, wherein the instructions, when executed, cause the one or more processors to perform operations comprising:
receiving, by a first machine learned model and from a user device, first input comprising a task;
generating, by the first machine learned model and based on the first input, an instruction prompt;
receiving, by a second machine learned model, the instruction prompt as a second input;
generating, by the second machine learned model and based on executing the second input, an output associated with the task;
receiving, by a third machine learned model, the output as a third input;
generating, by the third machine learned model and based on the third input, feedback data comprising values indicating whether the output meets one or more quality criteria of the task;
receiving, by the first machine learned model, the feedback data and the output; and
based on the feedback data indicating the values meet or exceed a threshold value, causing the output to be displayed via a user interface of the user device.
